(19) United States
(12) Patent Application Publication
(10) Pub. No.: US 2026/0122458 A1
(43) Pub. Date: Apr. 30, 2026

(54) METHOD, APPARATUS AND SYSTEM FOR SEMANTIC COMMUNICATIONS

(71) Applicant: Huawei Technologies Co., Ltd., Shenzhen (CN)

(72) Inventors: Yiqun Ge, Ottawa (CA); Mengyao Ma, Shenzhen (CN); Jianglei Ma, Ottawa (CA); Qifan Zhang, Ottawa (CA)

(21) Appl. No.: 19/425,929

(22) Filed: Dec. 18, 2025

Related U.S. Application Data
(63) Continuation of application No. PCT/CN2023/128916, filed on Oct. 31, 2023.
(60) Provisional application No. 63/509,453, filed on Jun. 21, 2023.

(51) Int. Cl. H04W 4/38; H04W 72/231; H04W 72/232

(52) U.S. Cl. CPC H04W 4/38; H04W 72/231; H04W 72/232

(57) ABSTRACT

Provided are a method and related products for semantic communications. The method includes: receiving a semantic token and a tokenization configuration from a central device; determining whether sensed data and the semantic token are matched, where the tokenization configuration is used for obtaining a sensing token from the sensed data; and transmitting a sensing result to the central device when the sensed data and the semantic token are matched, where the sensing result indicates the sensed data.

### CROSS-REFERENCE TO RELATED APPLICATIONS

This application is a continuation of International Application No. PCT/CN2023/128916, filed on October 31, 2023, which claims priority to US provisional patent application No. 63/509,453, entitled “METHOD, APPARATUS, AND SYSTEM FOR SEMANTIC COMMUNICATIONS” and filed on June 21, 2023, both of which are hereby incorporated by reference in its entirety.

### TECHNICAL FIELD

The present disclosure relates generally to the field of communication technologies and, in particular, to a communication method, a communication apparatus, a communication system and related products.

### BACKGROUND

A sensing function will be integrated into a 6th generation (6G) system. A large number of sensing user equipments (UEs) or sensing devices will be densely deployed in cities, factories, farms and so on. In addition to mobile phones, sensing devices will become an important type of UEs or devices that claim an arrival of internet of thing (IoT) time. Like internet searching engines, 6G will come up with the counterpart, an IoT searching engine, in a true physical world. In fact, billions of IoT-based applications such as driverless cars, automation factories, smart cities, autonomous farms, will heavily depend on an efficient and real-time searching engine in the physical world.

Recently, artificial intelligence (AI) has conquered various intellectual and cognitive domains. Some AI is exploring the cutting edge of intellectual knowledge in chemistry, gaming, mathematic, gene engineering; while some other AI is providing a human-level Q&A platform in the digital world. The domain that AI hasn’t conquered is real-time physical world. Physical-world AI, in which AI technologies are to penetrate into all aspects of the society and life, may be built on omnipresent IoT connections thanks to 6G.

More challenging than internet searching engines, a real-world searching engine would have to search the physical world in real time over a large scale of physical area and to deal with a multitude of types of data and information. Furthermore, green technology, low-energy and low-emission, are also raised as key features of 6G. A sensing device may be battery powered and/or completely powered by solar and wind. In some implementations, a sensing device may be a UE, a mobile phone or a handset, where independence among any two sensing devices are assumed; thereby, a sensing device may be scheduled individually by a wireless system to which the sensing device is associated; and sensed data that the sensing device measures may be application-level payload for the wireless system and protocol. The above scheme of scheduling a sensing device is inefficient in terms of radio bandwidth and energy consumption.

This background information is provided to reveal information believed by the applicant to be of possible relevance to the present application. No admission is necessarily intended, nor should be construed, that any of the preceding information constitutes prior art against the present application.

### SUMMARY

In a first aspect, a communication method is provided in the present disclosure, and the method includes:

receiving a semantic token and a tokenization configuration from a central device;

determining whether sensed data and the semantic token are matched, where the tokenization configuration is used for obtaining a sensing token from the sensed data; and

transmitting a sensing result to the central device when the sensed data and the semantic token are matched, where the sensing result indicates the sensed data.

The semantic token from the central device wakes a sensing device to measure and transmit the sensing result when the sensed data and the semantic token are matched, that is, the sensing device starts the computation of the matching determination in response to the semantic token, and may not start the computation of the matching determination under other circumstances, the energy consumption for the sensing device is thus reduced. Further, since the form of a semantic token may provide more accurate true intentions and save signaling overhead, accuracy of a matching result between the sensed data and the semantic token is thus improved and signaling overhead is saved. A tokenization configuration can be used for the tokenization of the sensed data, thereby ensuring the matching objects are in a common token form, such that the sensed data and the semantic token can be easily compared to each other. Moreover, the transmission of the sensing result is triggered when the sensed data and the semantic token are matched, that is, the sensing result is not transmitted all the time, thus the transmission resources are saved; in addition, the transmitted sensing result meets the requirement of the semantic token, hence, irrelevant information is filtered, the transmitted data is what the central device requires, responding accuracy is thus ensured.

In a possible implementation of the first aspect, the receiving the semantic token and the tokenization configuration from the central device includes:

receiving the semantic token and the tokenization configuration broadcasted or multicasted by the central device.

The received semantic token and tokenization configuration are broadcasted or multicasted by the central device, thus, the semantic token and the tokenization configuration can be transmitted to a plurality of sensing devices, the transmission efficiency is thus improved; and sensed data of the plurality of sensing devices can be tokenized through the same tokenization configuration, such that the sensing devices may determine to transmit their sensing result or not under the same criterion.

In a possible implementation of the first aspect, the semantic token includes a semantic token for one task or a semantic token for one modality.

The sensing device can serve for one task or one modality, i.e., the sensing device is dedicated to one task or one modality, the responding efficiency of the sensing device can thus be improved.

In a possible implementation of the first aspect, the method further includes:

receiving an indication for a task identifier or an indication for a modality identifier.

In a possible implementation of the first aspect, the semantic token includes multiple semantic tokens for multiple tasks and multiple task identifiers respectively associated with the multiple semantic tokens.

The sensing device can simultaneously serve for multiple tasks, resource utilization of the sensing device is thus improved.

In a possible implementation of the first aspect, the semantic token includes multiple semantic tokens for multiple modalities and multiple modality identifiers respectively associated with the multiple semantic tokens.

The sensing device can simultaneously serve for multiple modalities, i.e., the sensing device can sense and feedback more than one modality (i.e., one type of data), which enriching the variety of data with which the sensing device responds.

In a possible implementation of the first aspect, the semantic token includes first multiple semantic tokens for multiple tasks, second multiple semantic tokens for multiple modalities, multiple task identifiers respectively associated with the first multiple semantic tokens, and multiple modality identifiers respectively associated with the second multiple semantic tokens.

The sensing device can simultaneously serve for both multiple tasks and multiple modalities, thereby not only improving the resource utilization of the sensing device, but also enriching the variety of data with which the sensing device responds.

In a possible implementation of the first aspect, the sensing result includes one of the following:

raw sensed data;

a sensing semantic obtained from raw sensed data;

half raw sensed data and a sensing semantic obtained from raw sensed data;

raw sensed data and a matching score between the sensed data and the semantic token;

raw sensed data and a distance between the sensed data and the semantic token;

a sensing semantic obtained from raw sensed data and a matching score between the sensed data and the semantic token;

a sensing semantic obtained from raw sensed data and a distance between the sensed data and the semantic token;

half raw sensed data, a sensing semantic obtained from raw sensed data, and a matching score between the sensed data and the semantic token;

half raw sensed data, a sensing semantic obtained from raw sensed data, and a distance between the sensed data and the semantic token.

The sensing result may be in various forms related to the sensed data, which provides more flexibility and can thus meet different requirements.

In a possible implementation of the first aspect, the sensing result further includes a task identifier or a modality identifier.

The task identifier is used for distinguishing a certain task, and the modality identifier is used for distinguishing a certain modality. With the task identifier or the modality identifier being included in the sensing result, it may be easy for the central device to identify which task or which modality carried in a certain sensing result.

In a possible implementation of the first aspect, the sensing result further includes an identifier of a semantic token of which the matching score is greater than or equal to a first threshold or the distance is less than a second threshold.

The identifier of a semantic token is used for distinguishing a semantic token, and the semantic token of which the matching score is greater than or equal to the first threshold or the distance is less than the second threshold indicates that the sensing device has sensed data corresponding to the semantic token. With this identifier being included in the sensing result, it may be easy for the central device to identify which semantic token carried in a certain sensing result.

In a possible implementation of the first aspect, the sensing result further includes identifiers of semantic tokens of which matching scores are greater than or equal to a first threshold or distances are less than a second threshold.

In a possible implementation of the first aspect, the receiving the semantic token and the tokenization configuration from the central device includes:

receiving a sequence of a pre-defined length and the tokenization configuration from the central device.

The semantic token can be encoded into a sequence of a pre-defined length, therefore, the transmission of a semantic token can be integrated into the physical layer of a wireless communication system for the purpose of short latency.

In a possible implementation of the first aspect, the sequence of the pre-defined length includes an amble, a mask code, or an interleaving sequence.

In a possible implementation of the first aspect, the receiving the semantic token and the tokenization configuration from the central device includes:

receiving a payload with a fixed modulation and coding scheme (MCS) and the tokenization configuration from the central device.

The semantic token can be encoded as a payload with fixed MCS, such that a certain code can be directly employed to encode the semantic token, the transmission of a semantic token can be integrated into the physical layer of a wireless communication system for the purpose of short latency.

In a possible implementation of the first aspect, the method further includes:

obtaining the sensed data;

translating the sensed data into a sensing semantic according to a semantization configuration;

tokenizing the sensing semantic into the sensing token according to the tokenization configuration;

determining whether sensed data and the semantic token are matched includes:

determining whether the sensing token and the semantic token are matched.

In the case that the sensed data is in a form of natural language, the sensed data can be processed into the sensing token, then the comparison is implemented between the sensing token and the semantic token. Since the form of token may provide more accurate true intentions and save signaling overhead, accuracy of a comparing result is thus improved and signaling overhead is saved. Further, the tokenization can be used to prevent a sensing device from recovering a complete query message from a semantic token. The tokenization may come up with certain privacy protection for query messages.

In a possible implementation of the first aspect, the determining whether the sensing token and the semantic token are matched includes:

determining whether a matching score between the sensing token and the semantic token is greater than or equal to a first threshold; or

determining whether a distance between the sensing token and the semantic token is less than or equal to a second threshold.

The sensed data and the semantic token are matched or not can be implemented based on a matching score between the sensed data and the semantic token, or a distance between the sensed data and the semantic token, which provides an efficient implementation. It should be noted that other metrics such as the score of relevance between the sensed data and the semantic token or the similarity between the sensed data and the semantic token can also be used to indicate whether the sensed data and the semantic token are matched or not.

In a possible implementation of the first aspect, the tokenization configuration includes one of:

a tokenization model;

a tokenization function;

a projection matrix;

a graph-based or topology-based pruning; or

a compression approach.

There are a plurality of tokenization configurations to be chose, which provides more flexibility and can thus meet different requirements.

In a possible implementation of the first aspect, the method further includes:

receiving at least one of a scoring function for determining a matching score between the sensed data and the semantic token, a first threshold, a function for determining a distance between the sensed data and the semantic token, or a second threshold from the central device.

The matching score between the sensed data and the semantic token can be computed through a scoring function, the distance between the sensed data and the semantic token can be computed through a corresponding function, which provides an efficient implementation. At least one of the scoring function for determining the matching score, the first threshold, the function for determining the distance, the second threshold may be transmitted to the sensing device from the central device, which provides more flexibility and can thus meet different requirements.

In a possible implementation of the first aspect, the receiving the semantic token and the tokenization configuration from the central device includes:

receiving the semantic token, the tokenization configuration and at least one of a scoring function for determining a matching score between the sensed data and the semantic token, a first threshold, a function for determining a distance between the sensed data and the semantic token, or a second threshold from the central device.

At least one of the scoring function for determining the matching score, the first threshold, the function for determining the distance, the second threshold may be transmitted to the sensing device from the central device along with the semantic token and the tokenization configuration, which provides more flexibility and can thus meet different requirements.

In a possible implementation of the first aspect, the semantic token is carried in higher layer signaling or physical layer signaling or a combination of higher layer signaling and physical signaling, where the higher layer signaling includes one of radio resource control (RRC) signaling, medium access control (MAC) layer signaling, and the physical layer signaling includes downlink control information (DCI).

The semantic token can be transmitted to the sensing device from the central device through specific signaling, which ensures high security and efficiency of data transmission.

In a possible implementation of the first aspect, the semantic token includes a query token.

In a second aspect, a communication method is provided in the present disclosure, and the method includes:

transmitting a semantic token and a tokenization configuration to a sensing device; and

receiving a sensing result from the sensing device, where sensed data of the sensing device and the semantic token are matched, the tokenization configuration is used for obtaining a sensing token from the sensed data, and the sensing result indicates the sensed data.

The central device transmits the semantic token and the tokenization configuration to the sensing device, the form of a semantic token may provide more accurate true intentions and save signaling overhead, and a tokenization configuration can be used by the sensing device to tokenize the sensed data. The central device receives the sensing result in the case that the sensed data and the semantic token are matched, the received sensing result meets the requirement of the semantic token, that is, irrelevant information is filtered, the received data is what the central device requires, accuracy of data transmission is thus ensured.

In a possible implementation of the second aspect, the transmitting the semantic token and the tokenization configuration to the sensing device includes:

broadcasting or multicasting the semantic token and the tokenization configuration to a plurality of sensing devices.

The central device broadcasts or multicasts the semantic token and the tokenization configuration to a plurality of sensing devices, the transmission efficiency is thus improved; and sensed data of the plurality of sensing devices can be tokenized through the same tokenization configuration, such that the sensing devices may determine to transmit their sensing result or not under the same criterion.

In a possible implementation of the second aspect, the semantic token includes a semantic token for one task or a semantic token for one modality.

In a possible implementation of the second aspect, the method further includes:

transmitting an indication for a task identifier or an indication for a modality identifier.

In a possible implementation of the second aspect, the semantic token includes multiple semantic tokens for multiple tasks and multiple task identifiers respectively associated with the multiple semantic tokens.

In a possible implementation of the second aspect, the semantic token includes multiple semantic tokens for multiple modalities and multiple modality identifiers respectively associated with the multiple semantic tokens.

In a possible implementation of the second aspect, the semantic token includes first multiple semantic tokens for multiple tasks, second multiple semantic tokens for multiple modalities, multiple task identifiers respectively associated with the first multiple semantic tokens, and multiple modality identifiers respectively associated with the second multiple semantic tokens.

In a possible implementation of the second aspect, the sensing result includes one of the following:

raw sensed data;

a sensing semantic obtained from raw sensed data;

half raw sensed data and a sensing semantic obtained from raw sensed data;

raw sensed data and a matching score between the sensed data and the semantic token;

raw sensed data and a distance between the sensed data and the semantic token;

a sensing semantic obtained from raw sensed data and a matching score between the sensed data and the semantic token;

a sensing semantic obtained from raw sensed data and a distance between the sensed data and the semantic token;

half raw sensed data, a sensing semantic obtained from raw sensed data, and a matching score between the sensed data and the semantic token;

half raw sensed data, a sensing semantic obtained from raw sensed data, and a distance between the sensed data and the semantic token.

The sensing result may be in various forms related to the sensed data, which provides more flexibility and can thus meet different requirements.

In a possible implementation of the second aspect, the sensing result further includes a task identifier or a modality identifier.

The task identifier is used for distinguishing a certain task, and the modality identifier is used for distinguishing a certain modality. With the task identifier or the modality identifier being included in the sensing result, it may be easy for the central device to identify which task or which modality carried in a certain sensing result.

In a possible implementation of the second aspect, the sensing result further includes an identifier of a semantic token of which the matching score is greater than or equal to a first threshold or the distance is less than a second threshold.

In a possible implementation of the second aspect, the sensing result further includes identifiers of semantic tokens of which matching scores are greater than or equal to a first threshold or distances are less than a second threshold.

The identifier of a semantic token is used for distinguishing a semantic token, and the semantic token of which the matching score is greater than or equal to the first threshold or the distance is less than the second threshold indicates that the sensing device has sensed data corresponding to the semantic token. With this identifier being included in the sensing result, it may be easy for the central device to identify which semantic token carried in a certain sensing result.

In a possible implementation of the second aspect, the method further includes:

encoding the semantic token into a sequence of a pre-defined length;

the transmitting the semantic token and the tokenization configuration to the sensing device includes:

transmitting the sequence of the pre-defined length and the tokenization configuration to a sensing device.

The semantic token can be encoded into a sequence of a pre-defined length, therefore, the transmission of a semantic token can be integrated into the physical layer of a wireless communication system for the purpose of short latency.

In a possible implementation of the second aspect, the sequence of the pre-defined length includes an amble, a mask code, or an interleaving sequence.

In a possible implementation of the second aspect, the method further includes:

encoding the semantic token into a payload with a fixed modulation and coding scheme (MCS);

the transmitting the semantic token and the tokenization configuration to the sensing device includes:

transmitting the payload with the fixed MCS and the tokenization configuration to a sensing device.

The semantic token can be encoded as a payload with fixed MCS, such that a certain code can be directly employed to encode the semantic token, the transmission of a semantic token can be integrated into the physical layer of a wireless communication system for the purpose of short latency.

In a possible implementation of the second aspect, the semantic token includes a query token.

In a possible implementation of the second aspect, the method further includes:

receiving a semantic from a generative pre-trained transformer (GPT) device;

tokenizing the semantic into the semantic token;

outputting the sensing result to the GPT device.

The central device receives a semantic from the GPT device, and the semantic is processed into the semantic token. Next, the central device provides the semantic token and the tokenization configuration for a sensing device to make a decision, then receives the sensing result from the sensing device, and outputs the sensing result to the GPT device. The central device serves as a bridge between the sensing device and the GPT device, thereby assisting in smooth communication between the sensing device and the GPT device.

In a possible implementation of the second aspect, the method further includes:

determining the tokenization configuration.

There may be different tokenization configurations for the tokenization processing, an appropriate tokenization configuration may correspond to a specific tokenization, thereby ensuring high efficiency of data processing.

In a possible implementation of the second aspect, the method further includes:

determining a token length of the semantic token.

The determination of the token length of the semantic token can facilitate subsequent processing, for example, a token length of a sensing token may be the same length as the semantic token.

In a possible implementation of the second aspect, the tokenization configuration includes one of:

a tokenization model;

a tokenization function;

a projection matrix;

a graph-based or topology-based pruning; or

a compression approach.

There are a plurality of tokenization configurations to be chose, which provides more flexibility and can thus meet different requirements.

In a possible implementation of the second aspect, the method further includes: transmitting at least one of a scoring function for determining a matching score between the sensed data and the semantic token, a first threshold, a function for determining a distance between the sensed data and the semantic token, or a second threshold, to the sensing device.

The matching score between the sensed data and the semantic token can be computed through a scoring function, the distance between the sensed data and the semantic token can be computed through a corresponding function, which provides an efficient implementation. At least one of the scoring function for determining the matching score, the first threshold, the function for determining the distance, the second threshold may be transmitted to the sensing device from the central device, which provides more flexibility and can thus meet different requirements.

In a possible implementation of the second aspect, the transmitting the semantic token and the tokenization configuration to the sensing device includes:

transmitting the semantic token, the tokenization configuration and at least one of a scoring function for determining a matching score between the sensed data and the semantic token, a first threshold, a function for determining a distance between the sensed data and the semantic token, or a second threshold, to the sensing device.

At least one of the scoring function for determining the matching score, the first threshold, the function for determining the distance, the second threshold may be transmitted to the sensing device from the central device along with the semantic token and the tokenization configuration, which provides more flexibility and can thus meet different requirements.

In a possible implementation of the second aspect, the semantic token is carried in higher layer signaling or physical layer signaling or a combination of higher layer signaling and physical signaling, where the higher layer signaling includes one of radio resource control (RRC) signaling, medium access control (MAC) layer signaling, and the physical layer signaling includes downlink control information (DCI).

The semantic token can be transmitted to the sensing device from the central device through specific signaling, which ensures high security and efficiency of data transmission.

In a third aspect, a communication apparatus is provided in the present disclosure, the apparatus includes various modules configured to execute the method according to the first aspect or any possible implementation of the first aspect.

In a fourth aspect, a communication apparatus is provided in the present disclosure, the apparatus includes various modules configured to execute the method according to the second aspect or any possible implementation of the second aspect.

In a fifth aspect, a sensing device is provided in the present disclosure, the sensing device includes processing circuitry for executing the method according to the first aspect or any possible implementation of the first aspect.

In a sixth aspect, a central device is provided in the present disclosure, the central device includes processing circuitry for executing the method according to the second aspect or any possible implementation of the second aspect.

In a seventh aspect, a communication system is provided in the present disclosure, the communication system includes a sensing device according to the fifth aspect and a central device according to the sixth aspect.

In an eighth aspect, a chip is provided in the present disclosure, the chip includes an input/output (I/O) interface and a processor, where the processor is configured to call and run computer execution instructions stored in a memory, to enable a device installing with the chip to execute the method according to the first or second aspect or any possible implementation of the first or second aspect.

In a ninth aspect, a computer-readable medium is provided in the present disclosure, the computer-readable medium stores computer execution instructions which, when executed by a processor, causes the processor to execute the method according to the first or second aspect or any possible implementation of the first or second aspect.

In a tenth aspect, a computer program product is provided in the present disclosure, the computer program product includes computer execution instructions which, when executed by a processor, causes the processor to execute the method according to the first or second aspect or any possible implementation of the first or second aspect.

The present disclosure provides a communication method and related products. The central device transmits the semantic token and the tokenization configuration to the sensing device, the sensing device starts the computation of the matching determination in response to the semantic token. The form of a semantic token may provide more accurate true intentions and save signaling overhead, and a tokenization configuration can be used by the sensing device to tokenize the sensed data. The transmission of the sensing result is triggered in the case that the sensed data of the sensing device and the semantic token are matched, that is, the transmission of the sensing result for the sensing device has a specific condition, and the sensing result is not transmitted all the time, thus the transmission resources are saved; in addition, the transmitted sensing result meets the requirement of the semantic token, that is, irrelevant information is filtered, the transmitted data is what the central device requires, accuracy of data transmission is thus ensured.

### BRIEF DESCRIPTION OF THE DRAWINGS

The accompanying drawings are used to provide a further understanding of the present disclosure, constitute a part of the specification, and are used to explain the present disclosure together with the following specific example embodiments, but should not be construed as limiting the present disclosure.

FIG. 1 is a schematic illustration of a communication system according to one or more examples of the present disclosure.

FIG. 2 is another schematic illustration of a communication system according to one or more examples of the present disclosure.

FIG. 3 is a schematic illustration of basic component structure of a communication system according to one or more examples of the present disclosure.

FIG. 4 illustrates a block diagram of a device in a communication system according to one or more examples of the present disclosure.

FIG. 5 is a schematic flowchart of a communication method according to one or more examples of the present disclosure.

FIG. 6 is a schematic flowchart of another communication method according to one or more examples of the present disclosure.

FIG. 7 is a schematic flowchart of still another communication method according to one or more examples of the present disclosure.

FIG. 8 is still another schematic illustration of a communication system according to one or more examples of the present disclosure.

FIG. 9 is a schematic illustration of division for sensing devices according to one or more examples of the present disclosure.

FIG. 10 is a schematic illustration of interaction between devices in a communication system according to one or more examples of the present disclosure.

FIG. 11 is another schematic illustration of interaction between devices in a communication system according to one or more examples of the present disclosure.

FIG. 12 is a schematic illustration of generating a sequence of query messages in a communication system according to one or more examples of the present disclosure.

FIG. 13 is a schematic illustration of interaction between a central device and two sensing devices in a communication system according to one or more examples of the present disclosure.

FIG. 14 is another schematic illustration of interaction between a central device and two sensing devices in a communication system according to one or more examples of the present disclosure.

FIG. 15 is a schematic illustration of generating a query semantic by a GPT device in a communication system according to one or more examples of the present disclosure.

FIG. 16 is a schematic illustration of recovering a query message from a query semantic in a communication system according to one or more examples of the present disclosure.

FIG. 17 is a schematic illustration of generating a query token by a GPT device in a communication system according to one or more examples of the present disclosure.

FIG. 18 is a schematic illustration of responding to a query token from a central device by a sensing device according to one or more examples of the present disclosure.

FIG. 19 is a schematic illustration of a scoring operation implemented by a sensing device according to one or more examples of the present disclosure.

FIG. 20 is a schematic illustration of a sensing result according to one or more examples of the present disclosure.

FIG. 21 is a schematic illustration of generating query tokens by two GPT devices according to one or more examples of the present disclosure.

FIG. 22 is a schematic illustration of handling two query tokens with a common semantization model and two tokenization models by a sensing device according to one or more examples of the present disclosure.

FIG. 23 is a schematic illustration of handling two query tokens with a common semantization model and a common tokenization model by a sensing device according to one or more examples of the present disclosure.

FIG. 24 is a schematic illustration of handling two query tokens with two semantization models and two tokenization models by a sensing device according to one or more examples of the present disclosure.

FIG. 25 is a schematic illustration of handling two query tokens with two semantization models and a common tokenization model by a sensing device according to one or more examples of the present disclosure.

FIG. 26 is a schematic illustration of processing two sensing semantics independently according to one or more examples of the present disclosure.

FIG. 27 is a block diagram of a communication apparatus according to one or more examples of the present disclosure.

FIG. 28 is a block diagram of another communication apparatus according to one or more examples of the present disclosure.

### DETAILED DESCRIPTION OF THE ILLUSTRATIVE EMBODIMENTS

In the following description, reference is made to the accompanying figures, which form part of the present disclosure, and which show, by way of illustration, specific aspects of examples of the present disclosure or specific aspects in which examples of the present disclosure may be used. It is understood that examples of the present disclosure may be used in other aspects and include structural or logical changes not depicted in the figures. The following detailed description, therefore, is not to be taken in a limiting sense, and the scope of the present disclosure is defined by the appended claims.

To assist in understanding the present disclosure, examples of wireless communication systems and devices are described below.

Example communication systems and devices

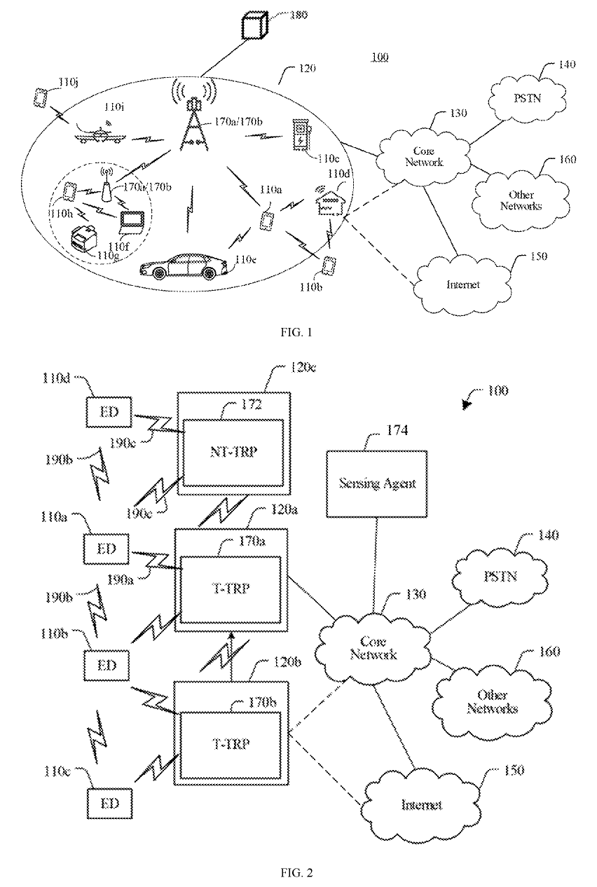

The present disclosure uses the interaction and processing procedures among at least one UE (i.e., the sensing device which is also called a sensing node, which is marked as ED in FIG. 1), at least one BS (i.e., the central device) and at least one GPT device in a wireless system as an illustrative example. The exchanged information and protocol flows can also be used between other network nodes described below, for example, between ED 110 and TRP 170, between ED 110 and core network, between ED 110 and ED 110, between TRP 170 and TRP 170, between TRP 170 and GPT device 180. The UE in the procedure described in the present disclosure may be replaced with a sensing node mentioned below. The BS in the procedure described in the present disclosure may be replaced with a sensing coordinator. The sensing coordinator are nodes in a network that can assist in the sensing operation. These nodes can be stand-alone nodes dedicated to just sensing operations or other nodes (for example TRP 170, ED 110, or core network node shown below) doing the sensing operations in parallel with communication transmissions.

Referring to FIG. 1, as an illustrative example without limitation, a simplified schematic illustration of a communication system is provided. The communication system 100 (which may be the wireless system in FIG. 1) comprises a radio access network 120. The radio access network 120 may be a next generation (e.g. sixth generation (6G) or later) radio access network, or a legacy (e.g. 5G, 4G, 3G or 2G) radio access network. One or more communication electric device (ED) 110a, 110b, 110c, 110d, 110e, 110f, 110g, 110h, 110i, 110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also the communication system 100 comprises a public switched telephone network (PSTN) 140, the internet 150, and other networks 160.

In addition, the communication system 100 comprises at least one GPT device 180. The GPT device 180 may be located within the one or more network node 170. The GPT device 180 may be an independent device connected to the network 170, such as an ED 110 which connected to the network node 170 via Uu interface. The GPT device 180 may be a device connected to the network node 170 vial core network 130. When the GPT device 180 is an ED, the uplink messages/data transmitted between the central device (e.g., the network node 170) and the GPT device 180 could be carried in higher layer signaling, such as RRC signaling, or MAC layer signaling. Or, they could be carried in physical layer signaling, e.g., UCI. Or they could be carried in the combination of the higher layer signaling and the physical signaling. It could be noted that the message in the present disclosure could be replaced with information, which may be carried in one single message, or be carried in more than one separate message. The downlink messages/data transmitted between the central device and the GPT device 180 could be carried in higher layer signaling, such as RRC signaling, or MAC layer signaling. Or, they could be carried in physical layer signaling, e.g., DCI. Or they could be carried in the combination of the higher layer signaling and the physical signaling. It could be noted that the message in the present disclosure could be replaced with information, which may be carried in one single message, or be carried in more than one separate message.

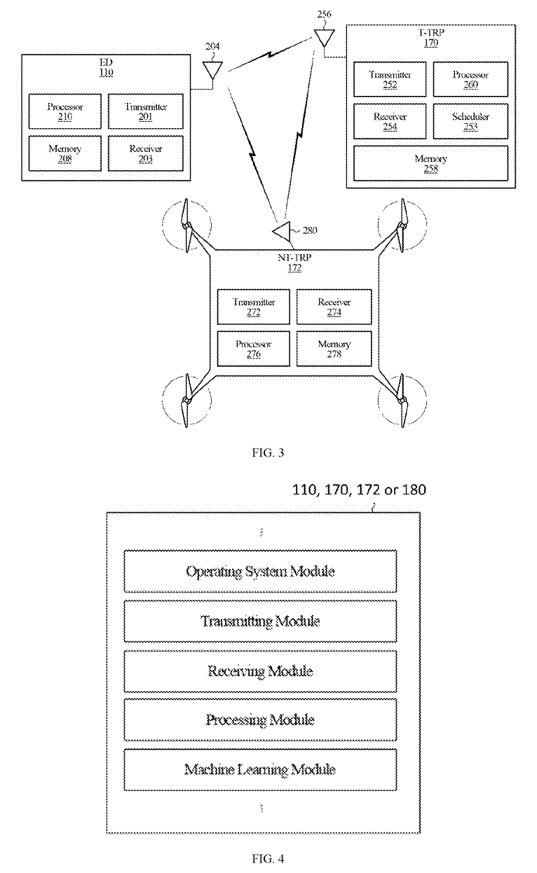

FIG. 2 illustrates an example communication system 100. In general, the communication system 100 enables multiple wireless or wired elements to communicate data and other content. The purpose of the communication system 100 may be to provide content, such as voice, data, video, signaling and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of a terrestrial communication system and a non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non- terrestrial networks.

The terrestrial communication system and the non-terrestrial communication system could be considered sub-systems of the communication system. In the example shown in FIG. 2, the communication system 100 includes electronic devices (ED) 110a, 110b, 110c, 110d (generically referred to as ED 110), radio access networks (RANs) 120a-120b, a non-terrestrial communication network 120c, a core network 130, a public switched telephone network (PSTN) 140, the Internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 172, which may be generically referred to as a non-terrestrial transmit and receive point (NT-TRP) 172.

Any ED 110 may be alternatively or additionally configured to interface, access, or communicate with any T-TRP 170a-170b and NT-TRP 172, the Internet 150, the core network 130, the PSTN 140, the other networks 160, or any combination of the preceding. In some examples, ED 110a may communicate an uplink and/or downlink transmission over a terrestrial air interface 190a with T-TRP 170a. In some examples, the EDs 110a, 110b, 110c and 110d may also communicate directly with one another via one or more sidelink air interfaces 190b. In some examples, ED 110d may communicate an uplink and/or downlink transmission over a non-terrestrial air interface 190c with NT-TRP 172.

The air interfaces 190a and 190b may use similar communication technology, such as any suitable radio access technology. For example, the communication system 100 may implement one or more channel access methods, such as code division multiple access (CDMA), space division multiple access (SDMA), time division multiple access (TDMA), frequency division multiple access (FDMA), orthogonal FDMA (OFDMA), Direct Fourier Transform spread OFDMA (DFT-OFDMA) or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The non-terrestrial air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs 110 and one or multiple NT-TRPs 172 for multicast transmission.

The RANs 120a and 120b are in communication with the core network 130 to provide the EDs 110a110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a110b, and 110c or both, and (ii) other networks (such as the PSTN 140, the Internet 150, and the other networks 160). In addition, some or all of the EDs 110a110b, and 110c may include functionality for communicating with different wireless networks over different wireless links using different wireless technologies and/or protocols. Instead of wireless communication (or in addition thereto), the EDs 110a110b, and 110c may communicate via wired communication channels to a service provider or switch (not shown), and to the Internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a110b, and 110c may be multimode devices capable of operation according to multiple radio access technologies, and incorporate multiple transceivers necessary to support such.

### B asic component structure

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), Internet of things (IOT), virtual reality (VR), augmented reality (AR), mixed reality (MR), metaverse, digital twin, industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, wearable devices such as a watch, head mounted equipment, a pair of glasses, an industrial device, or apparatus (e.g. communication module, modem, or chip) in the forgoing devices, among other possibilities. Future generation EDs 110 may be referred to using other terms. Each base station 170a and 170b is a T-TRP and will hereafter be referred to as T-TRP 170. Also shown in FIG.3, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas 204 may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by one or more processing unit(s) (e.g., a processor 210). Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the Internet 150 in FIG. 1). The input/output devices permit interaction with a user or other devices in the network. Each input/output device includes any suitable structure for providing information to or receiving information from a user, such as through operation as a speaker, a microphone, a keypad, a keyboard, a display, or a touch screen, including network interface communications.

The ED 110 includes the processor 210 for performing operations including those operations related to preparing a transmission for uplink transmission to the NT-TRP 172 and/or the T-TRP 170, those operations related to processing downlink transmissions received from the NT-TRP 172 and/or the T-TRP 170, and those operations related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by the NT-TRP 172 and/or by the T-TRP 170. In some embodiments, the processor 210 implements the transmit beamforming and/or the receive beamforming based on the indication of beam direction, e.g. beam angle information (BAI), received from the T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or from the T-TRP 170.

Although not illustrated, the processor 210 may form part of the transmitter 201 and/or part of the receiver 203. Although not illustrated, the memory 208 may form part of the processor 210.

The processor 210, the processing components of the transmitter 201 and the processing components of the receiver 203 may each be implemented by the same or different one or more processors that are configured to execute instructions stored in a memory (e.g. in the memory 208). Alternatively, some or all of the processor 210, the processing components of the transmitter 201 and the processing components of the receiver 203 may each be implemented using dedicated circuitry, such as a programmed field-programmable gate array (FPGA), a graphical processing unit (GPU), a Central Processing Unit (CPU) or an application-specific integrated circuit (ASIC).

In some implementations, the ED 110 may be an apparatus (also called component) for example, communication module, modem, chip, or chipset, it includes at least one processor 210, and an interface or at least one pin. In this scenario, the transmitter 201 and receiver 203 may be replaced by the interface or at least one pin, wherein the interface or at least one pin is to connect the apparatus (e.g., chip) and other apparatus (e.g., chip, memory, or bus). Accordingly, the transmitting information to the NT-TRP 172 and/or the T-TRP 170 and/or another ED 110 may be referred as transmitting information to the interface or at least one pin, or as transmitting information to the NT-TRP 172 and/or the T-TRP 170 and/or another ED 110 via the interface or at least one pin, and receiving information from the NT-TRP 172 and/or the T-TRP 170 and/or another ED 110 may be referred as receiving information from the interface or at least one pin, or as receiving information from the NT-TRP 172 and/or the T-TRP 170 and/or another ED 110 via the interface or at least one pin. The information may include control signaling and/or data.

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), a wireless router, a relay station, a remote radio head, a terrestrial node, a terrestrial network device, a terrestrial base station, a base band unit (BBU), a remote radio unit (RRU), an active antenna unit (AAU), a remote radio head (RRH), a central unit (CU), a distributed unit (DU), a positioning node, among other possibilities. The T-TRP 170 may be a macro BS, a pico BS, a relay node, a donor node, or the like, or combinations thereof. The T-TRP 170 may refer to the forgoing devices or refer to apparatus (e.g. a communication module, a modem, or a chip) in the forgoing devices.

In some embodiments, the parts of the T-TRP 170 may be distributed. For example, some of the modules of the T-TRP 170 may be located remote from the equipment that houses the antennas 256 for the T-TRP 170, and may be coupled to the equipment that houses the antennas 256 over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment that houses the antennas 256 of the T-TRP 170. The modules may also be coupled to other T-TRPs. In some embodiments, the T-TRP 170 may actually be a plurality of T-TRPs that are operating together to serve the ED 110, e.g. through the use of coordinated multipoint transmissions.

The T-TRP 170 includes at least one transmitter 252 and at least one receiver 254 coupled to one or more antennas 256. Only one antenna 256 is illustrated. One, some, or all of the antennas 256 may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to the NT-TRP 172, and processing a transmission received over backhaul from the NT-TRP 172. Processing operations related to preparing a transmission for downlink or backhaul transmission may include operations such as encoding, modulating, precoding (e.g. multiple input multiple output (MIMO) precoding), transmit beamforming, and generating symbols for transmission. Processing operations related to processing received transmissions in the uplink or over backhaul may include operations such as receive beamforming, demodulating received symbols and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates an indication of beam direction, e.g. BAI, which may be scheduled for transmission by a scheduler 253. The processor 260 performs other network-side processing operations described herein, such as determining the location of the ED 110, determining where to deploy the NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

The scheduler 253 may be coupled to the processor 260. The scheduler 253 may be included within or operated separately from the T-TRP 170. The scheduler 253 may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or part of the receiver 254. Also, although not illustrated, the processor 260 may implement the scheduler 253. Although not illustrated, the memory 258 may form part of the processor 260.

The processor 260, the scheduler 253, the processing components of the transmitter 252 and the processing components of the receiver 254 may each be implemented by the same or different one or more processors that are configured to execute instructions stored in a memory, e.g. in the memory 258. Alternatively, some or all of the processor 260, the scheduler 253, the processing components of the transmitter 252 and the processing components of the receiver 254 may be implemented using dedicated circuitry, such as a FPGA, a GPU, a CPU, or an ASIC.

When the T-TRP 170 is an apparatus (also called as component), for example, communication module, modem, chip, or chipset in a device, it includes at least one processor, and an interface or at least one pin. In this scenario, the transmitter 252 and receiver 254 may be replaced by the interface or at least one pin, wherein the interface or at least one pin is to connect the apparatus (e.g., chip) and other apparatus (e.g., chip, memory, or bus). Accordingly, the transmitting information to the NT-TRP 172 and/or the T-TRP 170 and/or ED 110 may be referred as transmitting information to the interface or at least one pin, and receiving information from the NT-TRP 172 and/or the T-TRP 170 and/or ED 110 may be referred as receiving information from the interface or at least one pin. The information may include control signaling and/or data.

Although the NT-TRP 172 is illustrated as a drone only as an example, the NT-TRP 172 may be implemented in any suitable non-terrestrial form, such as high altitude platforms, satellite, high altitude platform as international mobile telecommunication base stations and unmanned aerial vehicles, which forms will be discussed hereinafter. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, demodulating received symbols and decoding received symbols. In some embodiments, the processor 276 implements the transmit beamforming and/or receive beamforming based on beam direction information (e.g. BAI) received from the T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or part of the receiver 274. Although not illustrated, the memory 278 may form part of the processor 276.

The processor 276, the processing components of the transmitter 272 and the processing components of the receiver 274 may each be implemented by the same or different one or more processors that are configured to execute instructions stored in a memory, e.g. in the memory 278. Alternatively, some or all of the processor 276, the processing components of the transmitter 272 and the processing components of the receiver 274 may be implemented using dedicated circuitry, such as a programmed FPGA, a GPU, a CPU, or an ASIC. In some embodiments, the NT-TRP 172 may actually be a plurality of NT-TRPs that are operating together to serve the ED 110, e.g. through coordinated multipoint transmissions.

When the NT-TRP 172 is an apparatus (e.g. communication module, modem, chip, or chipset) in a device, it includes at least one processor, and an interface or at least one pin. In this scenario, the transmitter 272 and receiver 257 may be replaced by the interface or at least one pin, wherein the interface or at least one pin is to connect the apparatus (e.g., chip) and other apparatus (e.g., chip, memory, or bus). Accordingly, the transmitting information to the T-TRP 170 and/or another NT-TRP 172 and/or ED 110 may be referred as transmitting information to the interface or at least one pin, and receiving information from the T-TRP 170 and/or another NT-TRP 172 and/or ED 110 may be referred as receiving information from the interface or at least one pin. The information may include control signaling and/or data.

Note that “TRP”, as used herein, may refer to a T-TRP or a NT-TRP. A T-TRP may alternatively be called a terrestrial network TRP (“TN TRP”) and a NT-TRP may alternatively be called a non-terrestrial network TRP (“NTN TRP”).

The T-TRP 170, the NT-TRP 172, and/or the ED 110 may include other components, but these have been omitted for the sake of clarity.

Any or all of the EDs 110 and BS 170 may be sensing nodes in the system 100. Sensing nodes are network entities that perform sensing by transmitting and receiving sensing signals. Some sensing nodes are communication equipment that perform both communications and sensing. However, it is possible that some sensing nodes do not perform communications, and are instead dedicated to sensing. The sensing agent 174 is an example of a sensing node that is dedicated to sensing. Unlike the EDs 110 and BS 170, the sensing agent 174 does not transmit or receive communication signals. However, the sensing agent 174 may communicate configuration information, sensing information, signaling information, or other information within the communication system 100. The sensing agent 174 may be in communication with the core network 130 to communicate information with the rest of the communication system 100. By way of example, the sensing agent 174 may determine the location of the ED 110a, and transmit this information to the base station 170a via the core network 130. Although only one sensing agent 174 is shown in FIG. 2, any number of sensing agents may be implemented in the communication system 100. In some embodiments, one or more sensing agents may be implemented at one or more of the RANs 120.

A sensing node may combine sensing-based techniques with reference signal-based techniques to enhance UE pose determination. This type of sensing node may also be known as a sensing management function (SMF). In some networks, the SMF may also be known as a location management function (LMF). The SMF may be implemented as a physically independent entity located at the core network 130 with connection to the multiple BSs 170. In other aspects of the present application, the SMF may be implemented as a logical entity co-located inside a BS 170 through logic carried out by the processor 260.

Although not presented in FIG. 3, a GPT device 180 may be included, which has similar structure to ED 110, e.g., GPT device 180 includes at least one processor, a transmitting and a receiver.

### Basic module structure

One or more steps of the methods provided herein may be performed by corresponding units or modules, according to FIG. 4. FIG. 4 illustrates units or modules in a device, such as in the ED 110, in the T-TRP 170, in the NT-TRP 172, or in the GPT device 180. For example, a signal may be transmitted by a transmitting unit or by a transmitting module. A signal may be received by a receiving unit or by a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, a CPU, or an ASIC. It will be appreciated that where the modules are implemented using software for execution by a processor for example, the modules may be retrieved by a processor, in whole or part as needed, individually or together for processing, in single or multiple instances, and that the modules themselves may include instructions for further deployment and instantiation. The transmitter mentioned with reference to FIG. 3 may be a detailed implementation for the transmitting module. The receiver mentioned with reference to FIG. 3 may be a detailed implementation for the receiving module. The processor mentioned with reference to FIG. 3 may be a detailed implementation for the processing module.

Additional details regarding the EDs 110, the T-TRP 170, the NT-TRP 172 and the GPT device 180 are known to those of skill in the art. As such, these details are omitted here.

### Example concepts of some terms

Message: a payload in a natural language, e.g. English, French, Chinese, etc.

Query message: a query sentence in a natural language.

Sensing message: a description about an observation or sensed data in a natural language.

Semantic: a vector, a matrix, a tensor of scalars to embed a message.

Query semantic: a semantic that embeds a query message.

Sensing semantic: a semantic that embeds a sensing message.

Token: a vector of scalars encoded from a semantic.

Query token: a token that is encoded from a query semantic.

Sensing token: a token that is encoded from a sensing semantic.

GPT device: a device that runs over generative AI model or models to generate a query message or messages given a sensing message or messages.

Central device: a device as BS that connects a plurality of terminal devices via radio access in DL and UL, and connects with the core network via backbone network.

Sensing device: a device as terminal that connects to a BS or BSs and that is equipped with the sensing gadget to measure data of interest near it.

The above describes possible scenarios or generalized description of the examples of the present disclosure, the motivation and technical concepts of the present disclosure are illustrated in the following.

A sensing function will be integrated into the 6th generation (6G) system. A large number of the sensing user equipments (UEs) or sensing devices will be densely deployed in cities, factories, farms and so on. In addition to mobile phones, sensing devices will become an important type of UEs or devices that claim an arrival of IoT time.

Like internet searching engines, 6G will come up with the counterpart, an internet of thing (IoT) searching engine, in a true physical world. In fact, billions of IoT-based applications such as driverless cars, automation factories, smart cities, autonomous farms, will heavily depend on an efficient and real-time searching engine in our physical world.

Recently, artificial intelligence (AI) has conquered various intellectual and cognitive domains. some AI is exploring the cutting edge of our intellectual knowledge in chemistry, gaming, mathematic, gene engineering; some other AI is providing a human-level Q&A platform in the digital world; the domain that AI hasn’t conquered is real-time physical world. Physical-world AI, in which AI technologies are to penetrate into all the aspects of our society and life, may be built on omnipresent IoT connections thanks to 6G.

More challenging than internet searching engine, real-world searching engine would have to search the physical world in real time over a large scale of physical area and to deal with a multitude of types of data and information (some may be novel and some may haven’t been invented yet). Furthermore, green technology, low-energy and low-emission, are also raised as key feature of 6G. A sensing device may be battery powered and/or completely powered by solar and wind. It would be costly and impracticable to ask all the sensing devices in a large scale to feedback what they are sensing at the same time. On one hand, the frequent sensing and transmission consumes a sensing device much energy and reduce their battery life time; on other hand, such a high density of the IoT deployment may block the uplink channels, especially the uplink (UL) bandwidth is more expensive than the downlink (DL) one.

In some implementations, a sensing device may be a UE, a mobile phone or a handset, where independence among any two sensing devices are assumed; thereby, a sensing device may be scheduled individually by the wireless system to which the sensing device is associated; and the sensed data that the sensing device measures may be application-level payload for the wireless system and protocol.

The above scheme of scheduling a sensing device is inefficient in terms of radio bandwidth and energy consumption. For instance, a sensing device blindly keeps transmitting its sensed data to the central device, regardless of whether the sensed data is required or not.

From a higher level perspective, it is better to wake a plurality of sensing devices to measure and transmit only when their sensed data would serve a goal or goals; for example, when a generative pre-trained transformer (GPT) device such as a driverless car, may request the information about the moving obstacles near itself, it is useless to keep transmitting irrelevant information to the driverless car, or to transmit all the moving obstacles nearby to the car when the car is parking on the roadside.

To avoid any missing probability of the information, resources in the wireless system in above implementations may be over-scheduled.

The basic concepts of the present disclosure may be as follows. When receiving a semantic token, not all the sensing devices feedback what they are sensing, only the sensing devices whose sensed data has sufficient relevance with the semantic token (i.e., the sensed data and the semantic token are matched) would response and transmit their sensed data. For example, the central device (or referred to as BS) may broadcast semantic tokens for a query or other tasks, only sensing devices (or referred to as UEs) with corresponding results will feedback sematic results (i.e., a sensing result hereinafter).

The above briefly describes technical concepts of the present disclosure, and then specific examples of the present disclosure will be elaborated in the following description.

The present disclosure provides a communication method, as shown in FIG. 5, the method may be implemented by a sensing device, and may include the following steps.

Step 502, a sensing device receives a semantic token and a tokenization configuration from a central device.

The semantic token is used for retrieving related data from the sensing device, for example, the semantic token may be a semantic token for a query or other tasks, i.e., the semantic token may be a query token or a token for other tasks. The tokenization configuration can be used for the tokenization of the sensed data, it can be transmitted from the central device to the sensing device, and can also be predefined for the sensing device. Specific transmission manners of the semantic token and the tokenization configuration will be introduced later.

Step 504, the sensing device determines whether sensed data and the semantic token are matched, where the tokenization configuration is used for obtaining a sensing token from the sensed data.

The sensing device is responsible for measuring and/or collecting local physical-world data. It may be sensing UE, sensing equipment, IoT equipment, UE, mobile phones, handset, or other equipment. The sensing device may be equipped with a sensing gadget or component to measure local physical-world data which may be referred to as sensed data. Further, the sensing device may encode and transmit the sensed data to a central device.

The sensed data and the semantic token are matched or not can be implemented based on a matching score between the sensed data and the semantic token, or a distance between the sensed data and the semantic token, etc. The implementation details will be described later.

Step 506, the sensing device transmits a sensing result to the central device when the sensed data and the semantic token are matched, where the sensing result indicates the sensed data.

The central device may be a base station (BS), e.g. gNB, or eNB etc., or the central device may be an access point (AP). The sensing result is related to the sensed data obtained by the sensing device. If the sensed data and the semantic token are matched, the sensing device will respond with the sensing result. If the sensed data and the semantic token are not matched, the sensing device will not respond. Details about the specific contents and the transmission manner of the sensing result will be described later.

The semantic token from the central device wakes a sensing device to measure and transmit the sensing result when the sensed data and the semantic token are matched, that is, the sensing device starts the computation of the matching determination in response to the semantic token, and may not start the computation of the matching determination under other circumstances, the energy consumption for the sensing device is thus reduced. Further, since the form of a semantic token may provide more accurate true intentions and save signaling overhead, accuracy of a matching result between the sensed data and the semantic token is thus improved and signaling overhead is saved. A tokenization configuration can be used for the tokenization of the sensed data, thereby ensuring the matching objects are in a common token form, such that the sensed data and the semantic token can be easily compared to each other. Moreover, the transmission of the sensing result is triggered when the sensed data and the semantic token are matched, that is, the sensing result is not transmitted all the time, thus the transmission resources are saved; in addition, the transmitted sensing result meets the requirement of the semantic token, hence, irrelevant information is filtered, the transmitted data is what the central device requires, responding accuracy is thus ensured.

In a possible implementation, the sensing device may receive the semantic token and the tokenization configuration broadcasted or multicasted by the central device. It should be noted that in some circumstances, some sensing devices may actively transmit their sensing result without receiving any semantic token from the central device. The sensing devices that actively transmit the sensing result may respond to some urgency queries such as fire alarming or car accidents. In some sense, some queries have been pre-defined and configured into the system by default. The received semantic token and tokenization configuration are broadcasted or multicasted by the central device, thus, the semantic token and the tokenization configuration can be transmitted to a plurality of sensing devices, the transmission efficiency is thus improved; and sensed data of the plurality of sensing devices can be tokenized through the same tokenization configuration, such that the sensing devices may determine to transmit their sensing result or not under the same criterion.

The semantic token is goal-oriented or task-oriented, and may trigger a sensing device to complete one or more tasks, collect and transmit data of one or more modalities. It should be noted that a task and a modality may be independent, or may be related to each other. For example, the central device (or referred to as BS) may broadcast or multicast semantic token(s) for a single task, a single modality, multiple modalities, multiple tasks. In this case, the sensing device may feedback data of one or more modalities in response to one task, and sensed data of one modality may be the requested data corresponding to one or more tasks. Some implementations are illustrated in the following.

In a possible implementation, the semantic token includes a semantic token for one task or a semantic token for one modality. Specifically, the sensing device may receive an indication for a task identifier or an indication for a modality identifier. The indication for a task identifier and the indication for a modality identifier may be certain field(s), which is not limited here. The task identifier is used for distinguishing a certain task, and the modality identifier is used for distinguishing a certain modality. The sensing device can serve for one task or one modality, i.e., the sensing device is dedicated to one task or one modality, the responding efficiency of the sensing device can thus be improved.

In a possible implementation, the semantic token includes multiple semantic tokens for multiple tasks and multiple task identifiers respectively associated with the multiple semantic tokens. The sensing device can simultaneously serve for multiple tasks, resource utilization of the sensing device is thus improved.

In a possible implementation, the semantic token includes multiple semantic tokens for multiple modalities and multiple modality identifiers respectively associated with the multiple semantic tokens. The sensing device can simultaneously serve for multiple modalities, i.e., the sensing device can sense and feedback more than one type of data, which enriching the variety of data with which the sensing device responds.

In a possible implementation, the semantic token includes first multiple semantic tokens for multiple tasks, second multiple semantic tokens for multiple modalities, multiple task identifiers respectively associated with the first multiple semantic tokens, and multiple modality identifiers respectively associated with the second multiple semantic tokens. The sensing device can simultaneously serve for both multiple tasks and multiple modalities, thereby not only improving the resource utilization of the sensing device, but also enriching the variety of data with which the sensing device responds.

The above descries possible implementations of information included in the semantic token, and the transmission of the semantic token will be described below.

In a possible implementation, the sensing device may receive a sequence of a pre-defined length and the tokenization configuration from the central device. The semantic token can be encoded into a sequence of a pre-defined length, therefore, the transmission of a semantic token can be integrated into the physical layer of a wireless communication system for the purpose of short latency. Specifically, the sequence of the pre-defined length can be applied or transmitted in various forms, for example, an amble, a mask code, an interleaving sequence, etc. In another possible implementation, the sensing device may receive a payload with a fixed modulation and coding scheme (MCS) and the tokenization configuration from the central device. The semantic token can be encoded as a payload with fixed MCS, such that a certain code can be directly employed to encode the semantic token, the transmission of a semantic token can be integrated into the physical layer of a wireless communication system for the purpose of short latency.

Regarding the specific contents of the sensing result, in a possible implementation, the sensing result includes one of the following: raw sensed data; a sensing semantic obtained from raw sensed data; half raw sensed data and a sensing semantic obtained from raw sensed data; raw sensed data and a matching score between the sensed data and the semantic token; raw sensed data and a distance between the sensed data and the semantic token; a sensing semantic obtained from raw sensed data and a matching score between the sensed data and the semantic token; a sensing semantic obtained from raw sensed data and a distance between the sensed data and the semantic token; half raw sensed data, a sensing semantic obtained from raw sensed data, and a matching score between the sensed data and the semantic token; half raw sensed data, a sensing semantic obtained from raw sensed data, and a distance between the sensed data and the semantic token. The sensing result may be in various forms related to the sensed data, which provides more flexibility and can thus meet different requirements.

In a possible implementation, the sensing result further includes a task identifier or a modality identifier. The task identifier is used for distinguishing a certain task, and the modality identifier is used for distinguishing a certain modality. With the task identifier or the modality identifier being included in the sensing result, it may be easy for the central device to identify which task or which modality carried in a certain sensing result.

In a possible implementation, the sensing result further includes an identifier of a semantic token of which the matching score is greater than or equal to a first threshold or the distance is less than a second threshold. In another possible implementation, the sensing result further includes identifiers of semantic tokens of which matching scores are greater than or equal to a first threshold or distances are less than a second threshold. The identifier of a semantic token is used for distinguishing a semantic token, and the semantic token of which the matching score is greater than or equal to the first threshold or the distance is less than the second threshold indicates that the sensing device has sensed data corresponding to the semantic token. With this identifier being included in the sensing result, it may be easy for the central device to identify which semantic token carried in a certain sensing result.

Regarding the transmission manner of the sensing result, in a possible implementation, the sensing device may initiate a procedure of a random access, a state report (SR) or a buffer state report (BSR), so as to transmit the sensing result to the central device.

In an example, BS (or the foregoing mentioned central device) may broadcast or multicast semantic tokens (or referred to as query keys), where token k may be a compressed/privacy-protected version of original query q. For example, a message format for the query keys may be: {k₁, k₂, .., kₙ} for n queries, where n>=1. For another example, a message format may be: {{{t₁, {k_{1,1}, .., k_{1,n1}}},.., {tₘ, {k_{m,1}, .., k_{1m,nm}}}} for m tasks, each task tᵢ has nᵢ queries, m>=1, nᵢ >=1. Each token (or query key) k can be fixed length, and selected from a given length set {LEN_1, LEN_2, … LEN_P}, which may be easier for UE detection. The message can be carried in SSB for broadcast, or in multicast messages targeted to a group of UEs (or the foregoing mentioned sensing devices), or even dedicated to one UE.

UE receives/detects the semantic tokens, then obtains its semantic observation o (or embedding vector), gets its local semantic token c based on o, and compares c with {k₁, k₂, .., kₙ} or {k_{i,1}, k_{i,2}, .., k_{i, ni}}. If c matches any kⱼ, UE may determine to respond; otherwise UE may determine not to respond. BS can configure how to calculate semantic token c based on the semantic observation o, can configure how to calculate the distance between two tokens: d(c, kⱼ), and can configure the threshold t for response, i.e. UE will respond if d(c, kⱼ) < t. If UE determines to respond, it generates a semantic response, which includes the semantic observation o or the local semantic token c, represented by a length N vector, or Nⱼ×Mⱼ matrix. The semantic response also includes the identifier for the task, i.e., i, the identifier for the matched query qⱼ, i.e., j. If there are multiple matched queries, multiple identifiers can be included. In addition, the semantic response or the local semantic token can be compressed. If there are multiple observations or multiple semantic tokens, the semantic response can include multiple observations or multiple semantic tokens. UE initiates the following procedures to transmit the semantic response to BS: a random access, or a state report (SR), or a buffer state report (BSR), etc.

In a possible implementation, the sensing device may obtain the sensed data, translate the sensed data into a sensing semantic according to a semantization configuration, and tokenize the sensing semantic into the sensing token according to the tokenization configuration; then, may determine whether the sensing token and the semantic token are matched. It should be noted that a translating operation in the present disclosure refers to the semantization processing, and the translating operation can be replaced with an embedding operation, a converting operation, a transforming operation, etc. For example, the translating the sensed data into the sensing semantic can be replaced with embedding the sensed data into the sensing semantic, converting the sensed data into the sensing semantic, transforming the sensed data into the sensing semantic, etc. The specific means of the translating operation, the embedding operation, the converting operation, the transforming operation are not limited here. For example, the transforming operation can be implemented by using an existing manner. In the case that the sensed data is in a form of natural language, the sensed data can be processed into the sensing token, then the comparison is implemented between the sensing token and the semantic token. Since the form of token may provide more accurate true intentions and save signaling overhead, accuracy of a comparing result is thus improved and signaling overhead is saved. Further, the tokenization can be used to prevent a sensing device from recovering a complete query message from a semantic token. The tokenization may come up with certain privacy protection for query messages.

In a possible implementation, the tokenization configuration includes one of: a tokenization model; a tokenization function; a projection matrix; a graph-based or topology-based pruning; a compression approach. There are a plurality of tokenization configurations to be chose, which provides more flexibility and can thus meet different requirements. The above lists some implementations for the tokenization, the specific means of the tokenization implementations are not limited here. For example, the tokenization model can be implemented by using an existing manner.

In a possible implementation, when receiving the semantic token, the sensing device with a sensing function obtains sensed data, and determines whether the sensed data and the semantic token are matched. The specific means for determining whether the sensed data and the semantic token are matched may be as follows. If a matching score between the sensed data and the semantic token is greater than or equal to a first threshold, it is determined that the sensed data and the semantic token are matched; otherwise, it is determined that the sensed data and the semantic token are not matched. Or, if a distance between the sensed data and the semantic token is less than or equal to a second threshold, it is determined that the sensed data and the semantic token are matched; otherwise, it is determined that the sensed data and the semantic token are not matched. The sensed data and the semantic token are matched or not can be implemented based on a matching score between the sensed data and the semantic token, or a distance between the sensed data and the semantic token, which provides an efficient implementation. It should be noted that other metrics such as the score of relevance between the sensed data and the semantic token or the similarity between the sensed data and the semantic token can also be used to indicate whether the sensed data and the semantic token are matched or not.

In a possible implementation, the sensing device may receive at least one of a scoring function for determining a matching score between the sensed data and the semantic token, a first threshold, a function for determining a distance between the sensed data and the semantic token, or a second threshold from the central device. The matching score between the sensed data and the semantic token can be computed through a scoring function, the distance between the sensed data and the semantic token can be computed through a corresponding function, which provides an efficient implementation. At least one of the scoring function for determining the matching score, the first threshold, the function for determining the distance, the second threshold may be transmitted to the sensing device from the central device, which provides more flexibility and can thus meet different requirements.

In another possible implementation, the sensing device may receive the semantic token, the tokenization configuration and at least one of a scoring function for determining a matching score between the sensed data and the semantic token, a first threshold, a function for determining a distance between the sensed data and the semantic token, or a second threshold from the central device. At least one of the scoring function for determining the matching score, the first threshold, the function for determining the distance, the second threshold may be transmitted to the sensing device from the central device along with the semantic token and the tokenization configuration, which provides more flexibility and can thus meet different requirements.

It should be noted that at least one of the scoring function for determining the matching score, the first threshold, the function for determining the distance, the second threshold may be predefined for the sensing device, or may be transmitted by the central device to the sensing device along with the semantic token and the tokenization configuration, or may be transmitted to the sensing device before the central device transmits the semantic token and the tokenization configuration. The scoring function may be in a form of an inner product or a euclidean distance; and the function for determining the first distance may be in a form of an inner product, a cross-correlation matrix, or a cross-entropy function, the above implementation forms are only illustrative and not restrictive, it should be noted that there may be other methods to implement the above functions. This provides more flexibility and can thus meet different requirements. It should be noted that a threshold in the present disclosure may be predefined or selected according to actual needs.

In a possible implementation, the semantic token is carried in higher layer signaling or physical layer signaling or a combination of higher layer signaling and physical signaling, where the higher layer signaling includes one of radio resource control (RRC) signaling, medium access control (MAC) layer signaling, and the physical layer signaling includes downlink control information (DCI). The semantic token can be transmitted to the sensing device from the central device through specific signaling, which ensures high security and efficiency of data transmission.

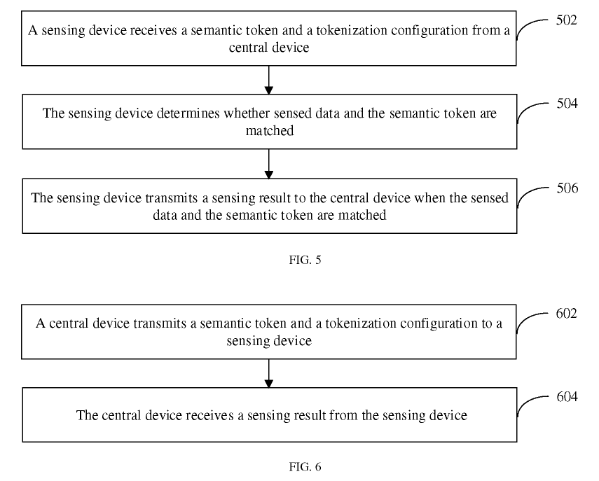

In the above, the communication method of the present disclosure is described from the perspective of the sensing device in combination with FIG. 5. In the following, a communication method of the present disclosure will be described from the perspective of a central device, and as shown in FIG. 6, the method can include the following:

step 602, a central device transmits a semantic token and a tokenization configuration to a sensing device; and

step 604, the central device receives a sensing result from the sensing device, where sensed data of the sensing device and the semantic token are matched, the tokenization configuration is used for obtaining a sensing token from the sensed data, and the sensing result indicates the sensed data.

Regarding the description for step 602 and step 604, reference may be made to the description for step 502 and step 506, which will not be repeated here. The central device transmits the semantic token and the tokenization configuration to the sensing device, the form of a semantic token may provide more accurate true intentions and save signaling overhead, and a tokenization configuration can be used by the sensing device to tokenize the sensed data. The central device receives the sensing result in the case that the sensed data and the semantic token are matched, the received sensing result meets the requirement of the semantic token, that is, irrelevant information is filtered, the received data is what the central device requires, accuracy of data transmission is thus ensured.

In a possible implementation, the central device may broadcast or multicast the semantic token and the tokenization configuration to a plurality of sensing devices. The central device broadcasts or multicasts the semantic token and the tokenization configuration to a plurality of sensing devices, the transmission efficiency is thus improved; and sensed data of the plurality of sensing devices can be tokenized through the same tokenization configuration, such that the sensing devices may determine to transmit their sensing result or not under the same criterion.

Next, the content included in the semantic token will be introduced briefly, details about the following possible implementations may be the same or similar to the description at the sensing device side, which is not repeated here.

In a possible implementation, the semantic token includes a semantic token for one task or a semantic token for one modality. Specifically, the central device may transmit an indication for a task identifier or an indication for a modality identifier.

In another possible implementation, the semantic token includes multiple semantic tokens for multiple tasks and multiple task identifiers respectively associated with the multiple semantic tokens.

In still another possible implementation, the semantic token includes multiple semantic tokens for multiple modalities and multiple modality identifiers respectively associated with the multiple semantic tokens.

In yet another possible implementation, the semantic token includes first multiple semantic tokens for multiple tasks, second multiple semantic tokens for multiple modalities, multiple task identifiers respectively associated with the first multiple semantic tokens, and multiple modality identifiers respectively associated with the second multiple semantic tokens.

Regarding the transmission of the semantic token, in a possible implementation, the central device may encode the semantic token into a sequence of a pre-defined length, and transmit the sequence of the pre-defined length and the tokenization configuration to a sensing device. The semantic token can be encoded into a sequence of a pre-defined length, therefore, the transmission of a semantic token can be integrated into the physical layer of a wireless communication system for the purpose of short latency. Specifically, the sequence of the pre-defined length can be applied or transmitted in various forms, for example, an amble, a mask code, an interleaving sequence, etc. In another possible implementation, the central device may encode the semantic token into a payload with a fixed modulation and coding scheme (MCS), and transmit the payload with the fixed MCS and the tokenization configuration to a sensing device. The semantic token can be encoded as a payload with fixed MCS, such that a certain code can be directly employed to encode the semantic token, the transmission of a semantic token can be integrated into the physical layer of a wireless communication system for the purpose of short latency.

Regarding the specific contents of the sensing result, in a possible implementation, the sensing result includes one of the following: raw sensed data; a sensing semantic obtained from raw sensed data; half raw sensed data and a sensing semantic obtained from raw sensed data; raw sensed data and a matching score between the sensed data and the semantic token; raw sensed data and a distance between the sensed data and the semantic token; a sensing semantic obtained from raw sensed data and a matching score between the sensed data and the semantic token; a sensing semantic obtained from raw sensed data and a distance between the sensed data and the semantic token; half raw sensed data, a sensing semantic obtained from raw sensed data, and a matching score between the sensed data and the semantic token; half raw sensed data, a sensing semantic obtained from raw sensed data, and a distance between the sensed data and the semantic token. The sensing result may be in various forms related to the sensed data, which provides more flexibility and can thus meet different requirements.

In a possible implementation, the sensing result further includes a task identifier or a modality identifier. The task identifier is used for distinguishing a certain task, and the modality identifier is used for distinguishing a certain modality. With the task identifier or the modality identifier being included in the sensing result, it may be easy for the central device to identify which task or which modality carried in a certain sensing result.

In a possible implementation, the sensing result further includes an identifier of a semantic token of which the matching score is greater than or equal to a first threshold or the distance is less than a second threshold. In another possible implementation, the sensing result further includes identifiers of semantic tokens of which matching scores are greater than or equal to a first threshold or distances are less than a second threshold. The identifier of a semantic token is used for distinguishing a semantic token, and the semantic token of which the matching score is greater than or equal to the first threshold or the distance is less than the second threshold indicates that the sensing device has sensed data corresponding to the semantic token. With this identifier being included in the sensing result, it may be easy for the central device to identify which semantic token carried in a certain sensing result.

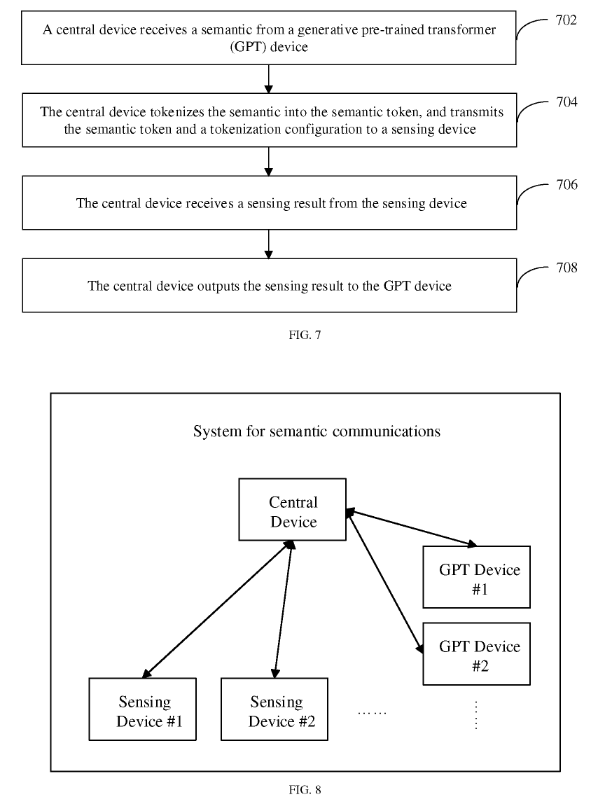

In a possible implementation, as shown in FIG. 7, the communication method includes:

step 702, a central device receives a semantic from a generative pre-trained transformer (GPT) device;

step 704, the central device tokenizes the semantic into the semantic token, and transmits the semantic token and a tokenization configuration to a sensing device;

step 706, the central device receives a sensing result from the sensing device, where sensed data of the sensing device and the semantic token are matched, the tokenization configuration is used for obtaining a sensing token from the sensed data, and the sensing result indicates the sensed data;

step 708, the central device outputs the sensing result to the GPT device.

Regarding the description for step 704 and step 706, reference may be made to the foregoing description, which will not be repeated here. The central device may perform tokenization processing on the received semantic from the GPT device, and then transmit the semantic token to the sensing devices. It should be noted that, the central device may directly forward the semantic from the GPT device to the sensing device without the tokenization processing, i.e., the tokenization processing may be performed by the sensing device, which is not limited here. The central device receives the semantic from the GPT device, provides the semantic token and the tokenization configuration for a sensing device to make a decision, then receives the sensing result from the sensing device, and outputs the sensing result to the GPT device. The central device serves as a bridge between the sensing device and the GPT device, thereby assisting in smooth communication between the sensing device and the GPT device.

In a possible implementation, the central device may determine the tokenization configuration, and then transmit the determined tokenization configuration to the sensing device. There may be different tokenization configurations for the tokenization processing, an appropriate tokenization configuration may correspond to a specific tokenization, thereby ensuring high efficiency of data processing. In a possible implementation, the central device may determine a token length of the semantic token. There may be a plurality of lengths for a semantic token, the central device may choose an appropriate token length for the semantic token. The determination of the token length of the semantic token can facilitate subsequent processing, for example, a token length of a sensing token may be the same length as the semantic token.

In a possible implementation, the tokenization configuration includes one of: a tokenization model; a tokenization function; a projection matrix; a graph-based or topology-based pruning; a compression approach. There are a plurality of tokenization configurations to be chose, which provides more flexibility and can thus meet different requirements.

In a possible implementation, the central device may transmit at least one of a scoring function for determining a matching score between the sensed data and the semantic token, a first threshold, a function for determining a distance between the sensed data and the semantic token, or a second threshold, to the sensing device. The matching score between the sensed data and the semantic token can be computed through a scoring function, the distance between the sensed data and the semantic token can be computed through a corresponding function, which provides an efficient implementation. At least one of the scoring function for determining the matching score, the first threshold, the function for determining the distance, the second threshold may be transmitted to the sensing device from the central device, which provides more flexibility and can thus meet different requirements.

In a possible implementation, the central device may transmit the semantic token, the tokenization configuration and at least one of a scoring function for determining a matching score between the sensed data and the semantic token, a first threshold, a function for determining a distance between the sensed data and the semantic token, or a second threshold, to the sensing device. At least one of the scoring function for determining the matching score, the first threshold, the function for determining the distance, the second threshold may be transmitted to the sensing device from the central device along with the semantic token and the tokenization configuration, which provides more flexibility and can thus meet different requirements.

It should be noted that at least one of the scoring function for determining the matching score, the first threshold, the function for determining the distance, the second threshold may be predefined for the sensing device, or may be transmitted by the central device to the sensing device along with the semantic token and the tokenization configuration, or may be transmitted to the sensing device before the central device transmits the semantic token and the tokenization configuration. The scoring function may be in a form of an inner product or a euclidean distance; and the function for determining the first distance may be in a form of an inner product, a cross-correlation matrix, or a cross-entropy function, the above implementation forms are only illustrative and not restrictive, it should be noted that there may be other methods to implement the above functions. This provides more flexibility and can thus meet different requirements. It should be noted that a threshold in the present disclosure may be predefined or selected according to actual needs.

In a possible implementation, the semantic token is carried in higher layer signaling or physical layer signaling or a combination of higher layer signaling and physical signaling, where the higher layer signaling includes one of radio resource control (RRC) signaling, medium access control (MAC) layer signaling, and the physical layer signaling includes downlink control information (DCI). The semantic token can be transmitted to the sensing device from the central device through specific signaling, which ensures high security and efficiency of data transmission.

In order to elaborate the communication methods of the present disclosure more clearly, in the following, taking the communication system including at least a central device, a plurality of distributed sensing devices and at least a GPT device as an example, the method will be described in more details with the following example embodiments.

### Embodiment 1

In the present disclosure, the wireless system is also called a communication system, or a wireless communication system. Herein the wireless system comprises a plurality of devices, for example, the plurality of devices comprise at least a central device, a plurality of distributed sensing devices and at least a GPT device (in FIG. 8).

The GPT device is responsible for encoding or decoding query messages and sensed data. In details, it generates a query message that contains one goal or more goals in natural language for the central device; the central device semantizes the query message into a semantic vector (i.e., the foregoing mentioned semantic), tokenizes the semantic vector into a goal semantic token (or vector) (i.e., the foregoing mentioned semantic token), and then broadcasts the goal semantic token to the sensing devices. A sensing device, triggered by receiving the goal semantic token, measures its sensed data and converts the sensed data into a sensed semantic token (i.e., the foregoing mentioned sensing token). The sensing device compares and scores the relevance between the goal semantic token and the sensed semantic token, and transmits the sensed data in semantic vector only if the score of relevance is higher than a threshold. The central device fuses the sensed data in semantic vectors, and outputs the fused one to the GPT device that will generate the next query message based on the fused input.

A central device may be a BS, e.g. gNB, or eNB etc., or the central device may be an access point (AP).

A sensing device is responsible for measuring and/or collecting local physical-world data. It may be sensing UE, sensing equipment, IoT equipment, UE, mobile phones, handset, or other equipment. The sensing device may be equipped with a sensing gadget or component to measure local physical-world data near it into sensed data; the sensing device encodes and transmits them to the central device.

A GPT device may generate a sequence of the query messages and receive a fused sensing message from the central device. In the present disclosure, the GPT device could be also called an AI agent device, a robot device, or a smart controlling device.

In details, a plurality of the sensing devices herein may be grouped or classified in terms of types of sensed data. The first group of the sensing devices may measure the first type of sensed data (e.g. red, green, blue (RGB) images or video), whereas the second group of sensing devices may measure the second type of sensed data (e.g. Radio RF point-cloud or Lidar Point cloud) as illustrated in FIG. 9. It should be noted that, some sensing devices can be grouped into more than one group, i.e., some sensing devices can measure more than one type of sensed data.

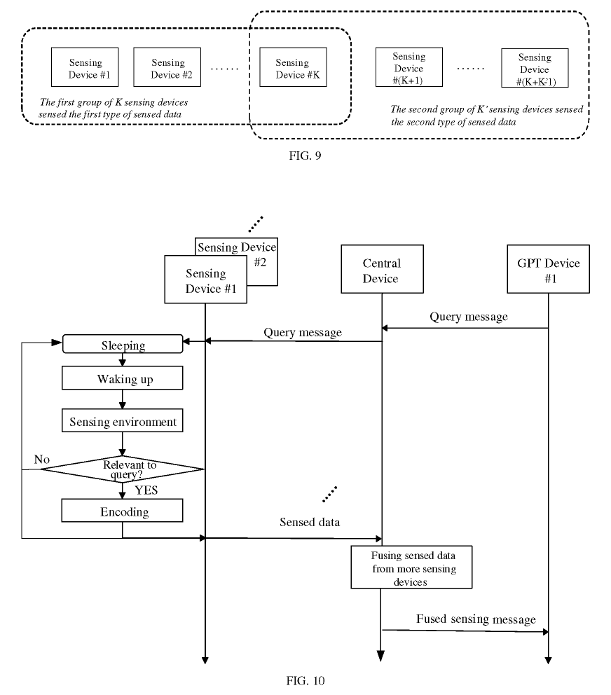

The central device actively requests or triggers the sensing devices to transmit their most recent sensed data (in FIG. 10). Accordingly, the sensing devices will transmit their sensed data.

The central device may transmit the first query message or messages to one or some sensing devices in DL broadcast, multicast, or unicast channel or channels, which may be in physical broadcast channel(s), shared channel, or dedicated channel(s).

After a sensing device receives the first query message, the sensing device decides whether or not to transmit its sensed data. In details, the sensing device decodes the first query message, measures its data, and decides whether or not to transmit its sensed data, which is called as responding to the first query message. If the sensing device decides to respond to the first query message, the sensing device would encode/encapsulate the sensed data into a payload and then transmit it to the central device in UL channel or channel(s), which may be physical UL shared channel or dedicated UL channel.

After the central device of the wireless system receives all the payloads (i.e., the foregoing mentioned sensing results) from the sensing devices that responded to the first query message, the central device may fuse all or some payloads into a fused payload. Optionally, the central device may input the fused payload into the GPT device that may process them and then generate the second query message.

The central device may transmit the second query message or messages to one or some sensing devices in DL broadcast, multicast, or unicast channel or channel(s).

The GPT device transmits the query message(s) to the central device to inform and configure the central device to schedule when, how, what, and which sensing devices to sense and transmit their sensed data to the central device. The GPT device may be implemented/located together with the central device for shorter latency, or the GPT device may be implemented in a remote data center, to which the central device may access via core network, or the GPT device may be on another connected device in the same wireless system of the central device. Please note that, in the present disclosure, the query message from the central device to the sensing device (downlink message) could be carried in higher layer signaling, such as radio resource control (RRC) signaling, or medium access control (MAC) layer signaling. Or, the query message could be carried in physical layer signaling, e.g., downlink control information (DCI). Or the query message is carried in the combination of the higher layer signaling and the physical signaling. It is similar for other downlink messages/data transmitted from the central device to the sensing device. Similarly, in the present disclosure, for uplink messages/data, they could be carried in higher layer signaling, such as RRC signaling, or MAC layer signaling. Or, they could be carried in physical layer signaling, e.g., uplink control information (UCI). Or they could be carried in the combination of the higher layer signaling and the physical signaling. It could be noted that the message in the present disclosure could be replaced with information, which may be carried in one single message, or be carried in more than one separate message.

The GPT device may generate a semantic, and transmit the semantic to the central device. The central device may tokenize the semantic into the semantic token, and transmit the semantic token and a tokenization configuration to a sensing device. In response to the semantic token from the central device, the sensing device may collect sensed data, translate the sensed data into a sensing semantic, and tokenize the sensing semantic into a sensing token according to the tokenization configuration. Then, the sensing device may determine whether the sensing token and the semantic token are matched. In the case that the sensing token and the semantic token are matched, the sensing device may transmit a sensing result (e.g., the sensed data) to the central device. It should be noted that, the semantic transmitted from the GPT device to the central device may be replaced with other forms, and the semantic token transmitted from the central device to the sensing device may also be replaced with other forms, e.g., the foregoing mentioned query messages or other forms. Further, the semantic and the semantic token may include a single query message, or more than one query message. Similarly, the fused sensing message is a specific form of a fused sensing result, and the fused sensing result may include a single fused sensing message, or more than one fused sensing message.

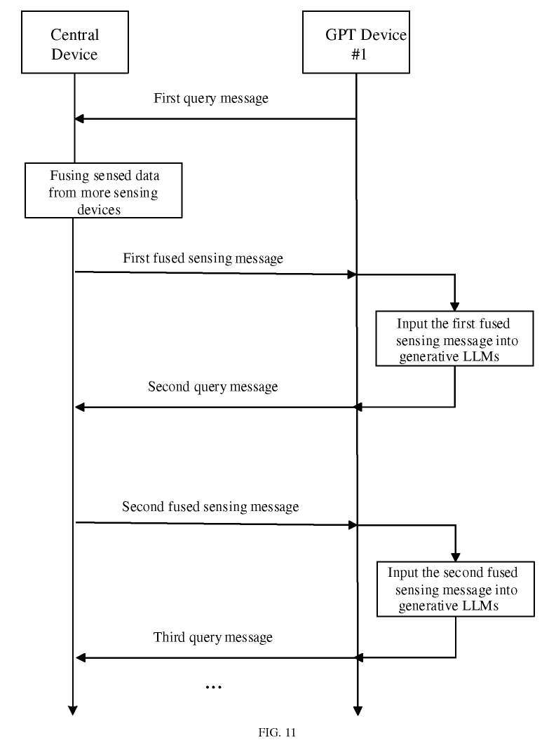

The wireless system comprising a central device, sensing devices, and a GPT device may form a series of interactions, in which the GPT device generates a sequence of the query messages for the sensing devices, the sensing devices collect and feedback the sensed data, and the central device fuses them and input them to the GPT device as illustrated in FIG. 11.

In some circumstances, some sensing devices may actively transmit their sensed data without receiving any query message from the central device. The sensing devices that transmit the sensed data may respond to some urgency queries such as fire alarming or car accidents. In some sense, some query messages have been pre-defined and configured into the system by default.

### Embodiment 2

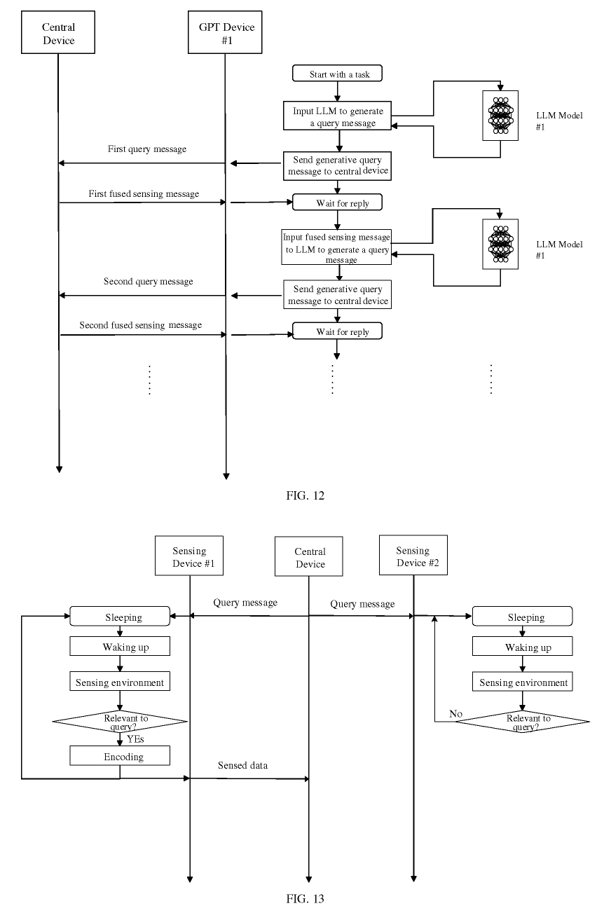

A GPT device in Embodiment 1 may generate a sequence of the query messages based on the previous sensing messages, wherein the previous sensing messages are received and/or fused by the central device. The GPT device may inference one or several generative AI models. The generative AI model or model inferences deep neural network or networks to output a query message or messages. The GPT device generates a sequence of the query messages, called as “a chain of the thoughts” by interacting with a sequence of the fused sensing messages into which the central device fuses the sensed data transmitted by the responsive sensing devices; as illustrated in FIG. 12.

A query message that the GPT device generates may convey semantic goals, tasks, or objectives. For example, a query message of “localize an incoming pedestrian” explicitly establishes a semantic goal for the sensing devices to focus on its nearby pedestrian and to prevent the sensing devices from being distracted. Since a query message conveys a semantic goal or goals, the query message that the central device transmits to the sensing devices may trigger a goal-oriented sensing task at each responsive sensing device that receives and responds to the very query message. Please note that a message may convey several goals. For example, a message of “find a moving pedestrian with a white coat” conveys two semantic goals or tasks: a moving pedestrian and a pedestrian with a white coat.

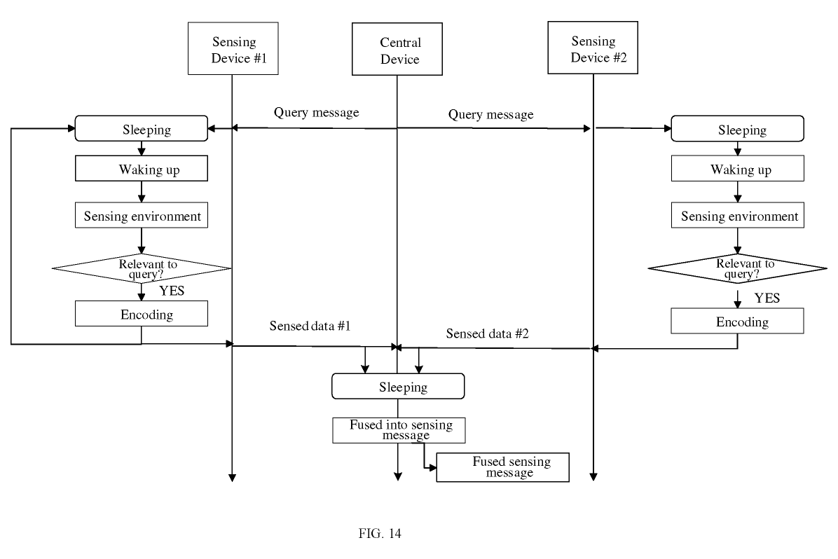

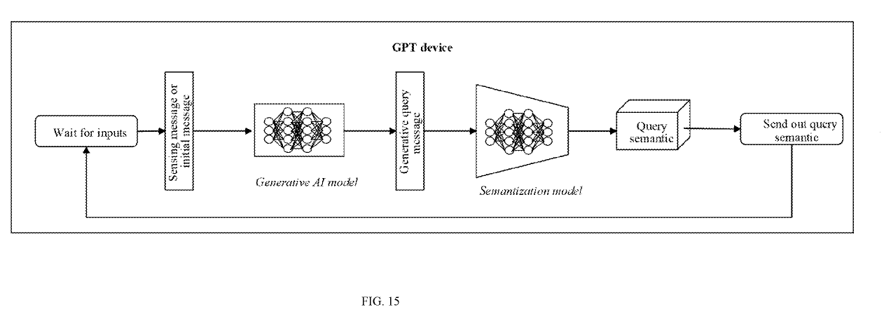

In an implementation, the central device may broadcast a sequence of the query messages, because it may be too costly or even forbidden to schedule a sensing device individually in a wireless system comprising such a high density of sensing devices. Therefore, once a sensing device receives a query message, the sensing device may become waken but with little idea whether or not its sensed data is sufficiently relevant to the goal conveyed by the query message. Thereby the sensing device may enable its sensing gadget to sense its nearby environment into sensed data and compare the sensed data with the query message. If the sensing device tells that the sensed data is sufficiently relevant with the query message, the sensing device encodes and transmits the sensed data to the central device (Sensing Device #1 in FIG. 13). Otherwise, the sensing may not respond to the query message at all (Sensing Device #2 in FIG. 13). In this sense, the wireless system doesn’t schedule an individual sensing device but schedule a common task across a collectivity of sensing devices.

The central device may receive a plurality of sensed data from some or all the sensing devices that respond to the query message at the end of a pre-defined responding timing interval. The central device may fuse all the sensed data into one sensing message and input the sensing message to the GPT device that would generate the next query message based on the sensing message, as shown in FIG. 14.

Because only those sensing devices that respond to the query message would transmit the sensed data, lots of radio resource would be saved in comparison with one-to-one scheduling algorithm.

### Embodiment 3

A sequence of the query messages in Embodiment 2 that the GPT device generates and the central device broadcasts is in a natural language, that is, human-readable. The GPT device may employ an LLM (large-language-model) to inference over a fused sensing message (in a natural language too) input to generate a new query message. The LLM model may be a “standard” foundation model like a transformer, or a “custom” model that is built for a narrower vocabulary and specific scenario. For example, a customized LLM for dealing with industry 4.0 or a customized LLM for dealing with wireless communication signaling and protocols. The GPT device may change, update, downsize, upsize, replace its LLM or LLMs anytime as it wishes. Please note that broadcast, multicast or unicast is allowed.

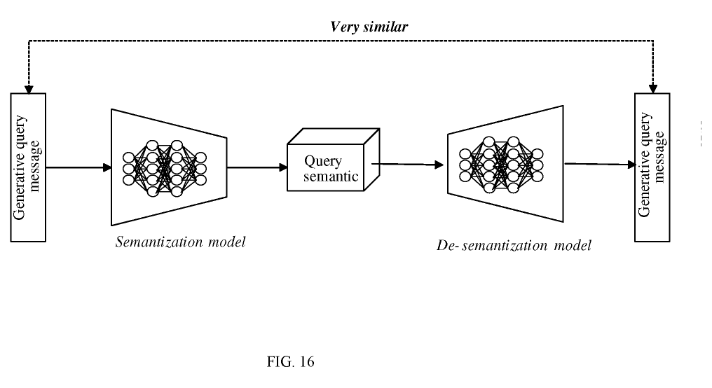

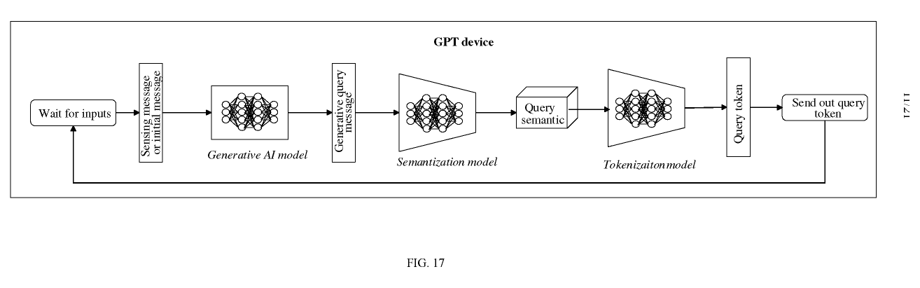

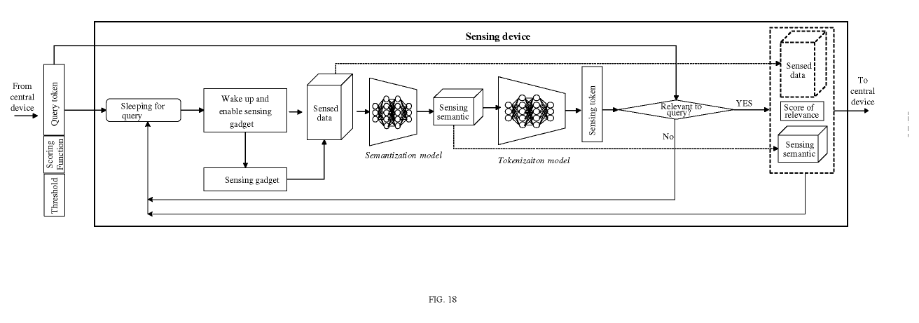

A query message in Embodiment 2 that the GPT device generates is in a natural language. Because of randomness in generating, two different query messages may convey very similar semantic goal or goals. For example, “find a pedestrian” and “localize a walking man” may have the same semantic goal. Therefore, the GPT device may semantize a query message into a query semantic, which is called as “embedding”, “semantization”, “encoding”, “natural-language to machine translation” and so on. The GPT device may translate a query message into a query semantic that may comprise a vector, a matrix, or a tensor of scalars. The translation may be realized by the deep-neural network or other classic functions. A query semantic may preserve all the key semantic goals conveyed by the query message such that the query semantic can be well translated (de-semantized) back to a query message. Optionally, the GPT device may transmit a query semantic instead of a query message to the central device, as illustrated in FIG. 15. As illustrated in FIG. 16, the query semantic is reversible, which means that the query message can be recovered from the query semantic. Please note that if all the LLMs output a common natural language (e.g. English), these LLMs are said to be aligned by the natural language; then whatever LLMs are used, everyone can be smoothly hooked into the GPT device and work well within the wireless system.

In an implementation, the central device may further tokenize a query semantic into a query token. A query token is a fixed-length semantic but comprising a vector of scalars, simpler for transmission and comparison purposes. The wireless system may pre-specify a plurality of lengths for query tokens. Thus, the central device may choose a right token length when tokenizing a query semantic according to the size range of the query semantic. The tokenization can be such a harsh function to prevent a sensing device from recovering a complete query message from a query token. The tokenization may come up with certain privacy protection for query messages. The tokenization may be realized by the deep-neural network or other classic functions; as shown in FIG. 17.

Optionally, the central device receives a query semantic from the GPT device, and then the central device converts the query semantic into a query token with a fixed length; the central device may broadcast the query token with the length to all the sensing devices; the central device may keep the query semantic in its memory or storage to check the feedback sensed data.

As in Embodiment 2, a sensing device may compare its sensed data with the query message; after the sensing device receives a query token (with its length or indicator of its length), the sensing device is waked up to enable its sensing gadget to measure its nearby physical-word environment into sensed data; the sensing device may be equipped with one LLM or more LLMs as a semantization model and input the sensed data into the semantization model to output a sensing semantic; optionally, the sensing device may choose a right length and format of the sensing semantic; and the sensing device may continue to tokenize the sensing semantic into a sensing token with the same length as the query token that the sensing device has received; the sensing device compares or scores the relevance between the query message and sensed data, which is based on what the sensing device has received.

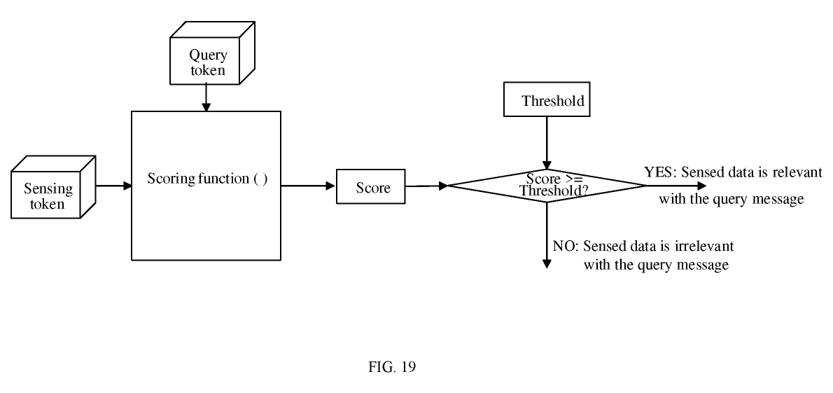

Alternative #1 (FIG. 18 and FIG. 19): the sensing device receives a query token and scoring function; it compares and scores the relevance between the query token and the sensing token; if the score of relevance was greater than or equal to a pre-defined threshold, the sensing device would tell that the sensed data is sufficiently relevant with the query message from the central device.

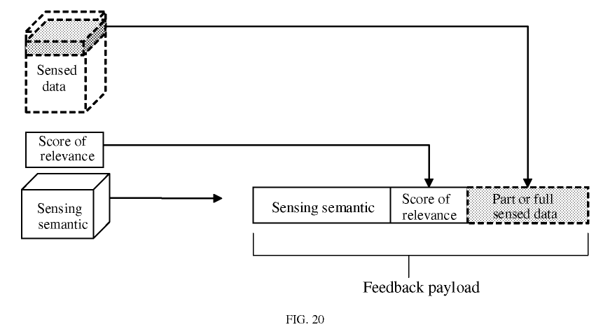

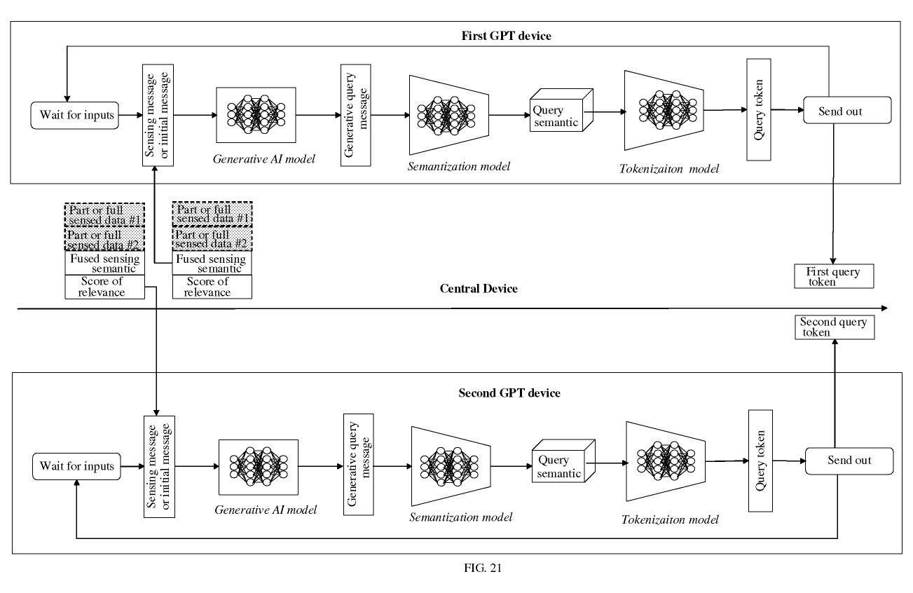

If the score of relevance is greater than or equal to a pre-defined threshold, the sensing device may transmit information (i.e., the foregoing mentioned sensing result) comprising the sensed data and the score of relevance to the central device (FIG. 20). The following are some alternatives of the contents in the transmitted information:

Alternative #1: raw sensed data + score of relevance

Alternative #2: sensing semantic + score of relevance

Alternative #3: half raw sensed data (e.g. exact value or number) + sensing semantic + score of relevance.

A sensing device may be equipped with one or several semantization models to generate a sensing semantic from sensed (raw) data, may be equipped with tokenization model to generate a sensing token from a sensing semantic, and may be configured to have a scoring function; unlike the GPT device, the LLMs, the tokenization model, and the scoring functions that a sensing device may use are configured by the central device; the central device may configure and inform the sensing devices of a common LLMs and/or a tokenization model and a scoring function at all the beginning or on the run.

### Embodiment 4

The scoring function in Embodiment 3 that scores the relevance between a query token and a sensing token can be realized by a scoring function. The scoring function may be an inner product, or a dot product, a euclidean distance, or other scoring functions.

In whichever scoring function is used, the central device has to inform and configure all the sensing device to use the same scoring function either explicitly or implicitly in order that the scores of relevance in Embodiment 3 from different sensing devices could be comparable at the central device; the central device may configure and inform the sensing devices of a common scoring function at all the beginning in the DL message, or the scoring function or a list of the scoring functions is specified in the structure, or the scoring function is indicated with the query semantic in DL.

### Embodiment 5

A plurality of sensing devices, either in one type or in multiple types, may serve one or several tasks simultaneously; in an efficient way, a sensing device may be triggered once to serve as many tasks as possible.

A wireless system may comprise two GPT devices, or one GPT device that can conduct two separated tasks; in the following disclosure, two GPT devices is mentioned as an example. And the two GPT devices may be easily extended to one GPT device with two separated tasks.

Although the two GPT devices have their own separate and independent tasks, the two GPT devices may trigger the same sensing devices simultaneously; for example, a driverless car GPT device and a traffic-light GPT device may trigger the same roadside camera sensing devices; nevertheless, although the same sensing devices may be triggered by two GPT devices at the same time interval, the query message from the first GPT device may be different from the query message from the second GPT device; for example, the driverless car GPT device may broadcast a query message about “moving obstacles” and the traffic-light GPT device may broadcast a query message about “density of vehicles”, both of which may be somehow relevant but not similar.

The first GPT device generates the first query semantic to the central device and the second GPT device generates the second query semantic to the central device. There are two options shown as follows.

Alternative #1: the central device may tokenize the first query semantic into the first query token and tokenize the second query semantic into the second query token; the central device may use the first tokenization model to tokenize the first query semantic and the second tokenization model to tokenize the second query semantic, or the central device may use a common tokenization model to tokenize the first query semantic and the second query semantic; then the central device may broadcast the first query token, the length of the first query token, the first scoring function related to the first query token, and the first threshold related to the first scoring function, and the second query token, the length of the second query token, the second scoring function related to the second query token, and the second threshold related to the second scoring function in a multiplex way in DL channel(s).

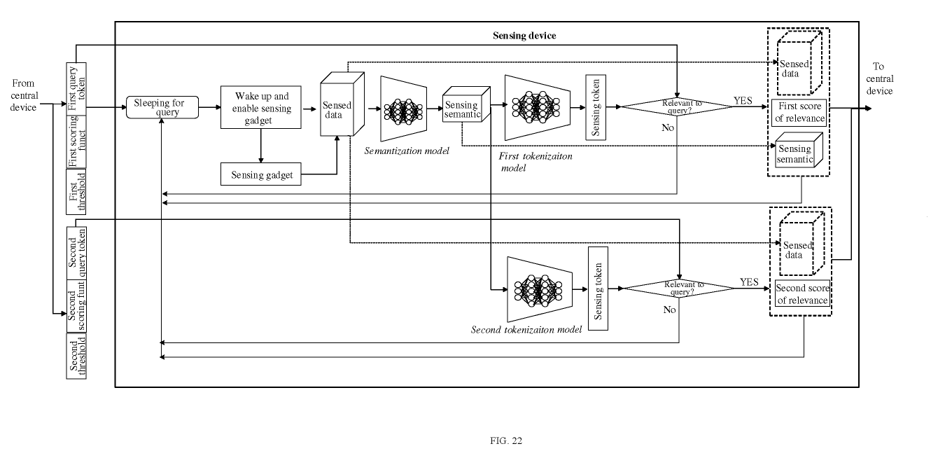

In another example, as illustrated in FIG. 21, the first GPT device generates the first query token to the central device, and the second GPT device generates the second query token to the central device. In this case, the central device may directly transmit the first query token and the second query token to a sensing device. A sensing device may receive both the first query token and the second query token and wakes to enable its sensing gadget to sense the physical-world around itself into sensed data. There are two options shown as follows.

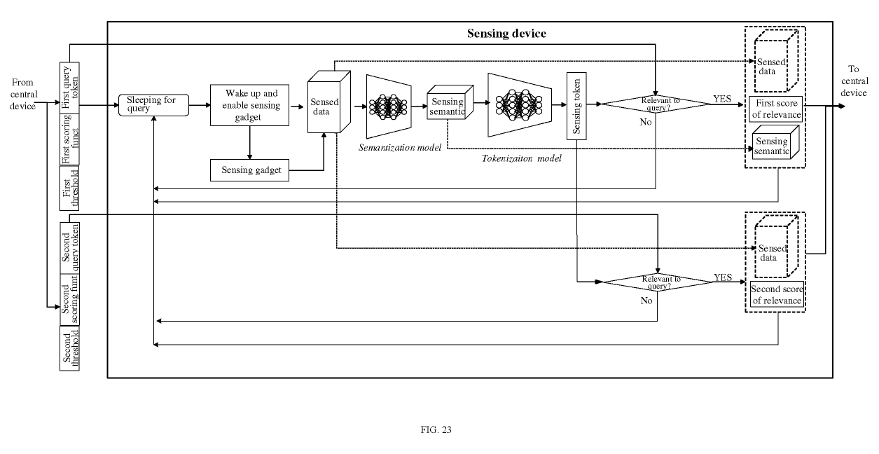

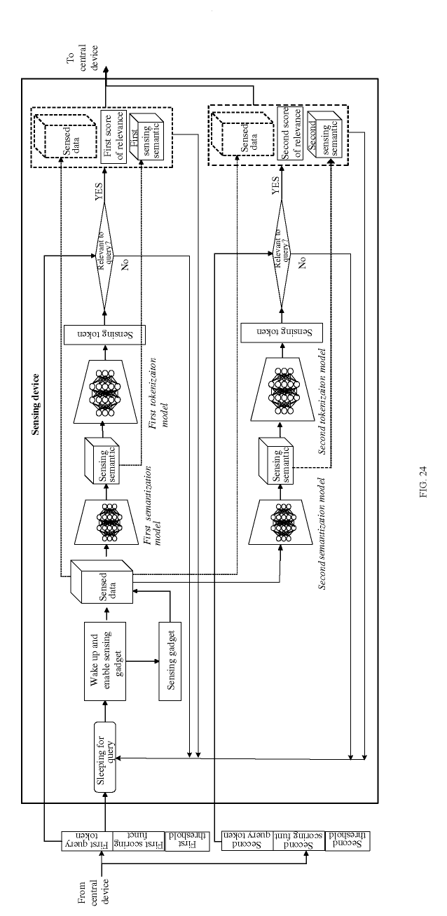

Alternative #1: the sensing device may convert the sensed data into one common sensing semantic by one LLM or more LLMs; and then the sensing device may tokenize the sensing semantic into the first sensing token in terms of the length of the first query token and tokenize the sensing semantic into the second sensing token in terms of the length of the second query token, in which the sensing device may use the first tokenization model to tokenize the sensing semantic into the first sensing token, and use the second tokenization model to tokenize the sensing semantic into the second sensing token (FIG. 22), or may use a common tokenization model to tokenize the sensing semantic into both the first sensing token and the second sensing token (FIG. 23); the sensing device may score the relevance between the first query token and the first sensing token and the relevance between the second query token and the second sensing token; the sensing device may tell the sensed data provides an enough relevance to the first query token if the first score of the relevance is greater than or equal to the first threshold, and the sensing device may tell the sensed data provides an enough relevance to the second query token if the second score of the relevance is greater than or equal to the second threshold; the sensing device may transmit at least one of the sensed data, the sensing semantic or the first score of relevance (in Embodiment 3) if deciding the first score of relevance is high enough; the sensing device may transmit at least one of the sensed data, the sensing semantic or the second score of relevance (in Embodiment 3) if deciding the second score of relevance is high enough.

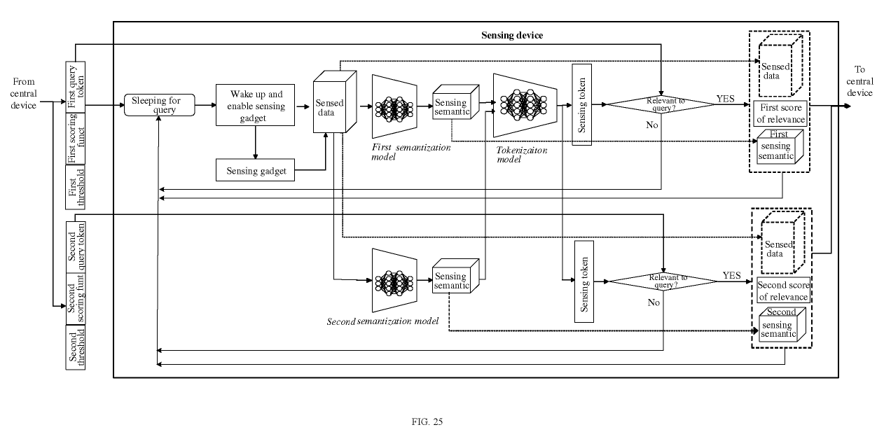

Alternative #2: the sensing device may convert the sensed data into the first sensing semantic by one LLM or more LLMs and convert the same sensed data into the second sensing semantic by one LLM or more LLMs; and then the sensing device may tokenize the first sensing semantic into the first sensing token in terms of the length of the first query token and tokenize the second sensing semantic into the second sensing token in terms of the length of the second query token, in which the sensing device may use the first tokenization model to tokenize the first sensing semantic into the first sensing token, and use the second tokenization model to tokenize the second sensing semantic into the second sensing token (FIG. 24), or may use a common tokenization model to tokenize the sensing semantic into both the first sensing token and the second sensing token (FIG. 25); the sensing device may score the relevance between the first query token and the first sensing token and the relevance between the second query token and the second sensing token; the sensing device may tell the sensed data provides an enough relevance to the first query token if the first score of the relevance is greater than or equal to the first threshold, and the sensing device may tell the sensed data provides an enough relevance to the second query token if the second score of the relevance is greater than or equal to the second threshold; the sensing device may transmit at least one of the sensed data, the first sensing semantic or the first score of relevance (in Embodiment 3) if deciding the first score of relevance is high enough; the sensing device may transmit at least one of the sensed data, the second sensing semantic or the second score of relevance (in Embodiment 3) if deciding the second score of relevance is high enough.

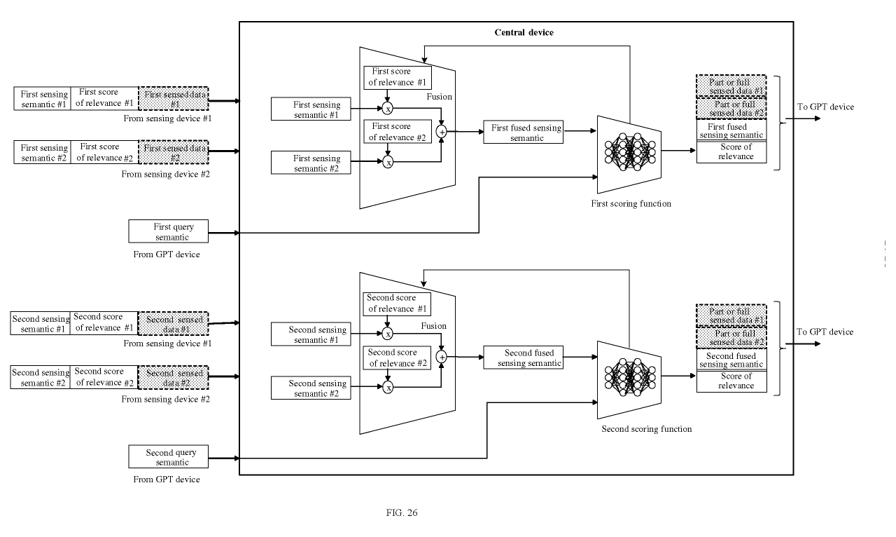

If the central device receives a number of the first sensing semantics plus the first scores of relevance and a number of the second sensing semantics plus the second scores of relevance, the central device may fuse these first sensing semantics according to their first scores of relevance as mentioned in Embodiment 4 into the first fused sensing semantic and the central device may fuse these second sensing semantics according to their second scores of relevance as mentioned in Embodiment 4 into the second fused sensing semantic; the central device may score the first fused sensing semantic by measuring the relevance between the first fused sensing semantic and the first query semantic as mentioned in Embodiment 4, and score the second fused sensing semantic by measuring the relevance between the second fused sensing semantic and the second query semantic as mentioned in Embodiment 4; the central device may transmit the first fused sensing semantic with the first score of relevance to the first GPT device and transmit the second fused sensing semantic with the second score of relevance to the second GPT device; as shown in FIG. 26.

### Embodiment 6

The transmission of a query token (or semantic) in Embodiment 3 can be integrated into the physical layer of a wireless communication system for the purpose of the short latency, i.e. a fast physical-world search. For example, the query token (or semantic) may be carried in the physical layer signaling.

A query token, as mentioned in Embodiment 3, may be a fixed length of a vector of scalars, while a sensing device may generate a sensing token with the same length as its query token; a query token can be encoded in the following possible ways.

Alternative #1: a query token can be encoded into a sequence of a pre-defined length; in the wireless system a sequence of a pre-defined length can be applied (transmitted) in various forms, such as ambles (pre, post, or mid), mask codes (over ambles, over pilots, over spreading codes), interleaving sequence, or others.

Alternative #2: a query token can be encoded as a special payload with fixed MCS schemes; for example, the lengths of a token can be power-of-two, so that a polar code with puncturing can be directly employed to encode a query token.

Alternative #3: if an inner product was used as a scoring function, a long query token can be divided into several sub-blocks for incremental transmissions; if the inner product on the first sub-block has already given a strong correlation, the following sub-block could be saved.

The transmission of a token score (or semantic) in Embodiment 5 can be integrated into the physical layer of a wireless communication for the purpose of the short latency, i.e. a fast physical-world search. For example, the query token (or semantic) may be carried in the physical layer signaling.

A token score as mentioned in Embodiment 5 may be a scalar, while a sensing device may generate a token scalar; a token scalar can be encoded.

In the wireless system, a scalar can be applied (transmitted) in various forms, such as ambles (pre, post, or mid), mask codes (over ambles, over pilots, over spreading codes), interleaving sequence, or others.

Next, example embodiments of products related to the communication methods will be described.

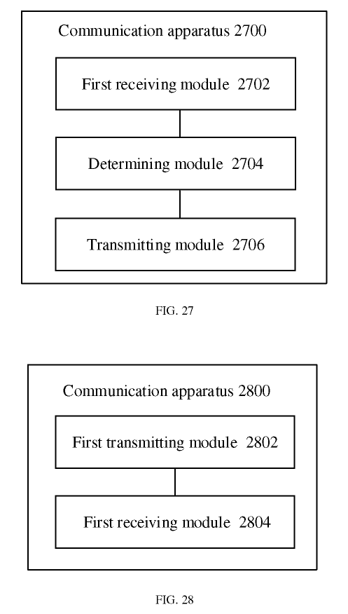

FIG. 27 illustrates a block diagram of a communication apparatus 2700. As shown in FIG. 27, the apparatus 2700 includes:

a first receiving module 2702, configured to receive a semantic token and a tokenization configuration from a central device;

a determining module 2704, configured to determine whether sensed data and the semantic token are matched, where the tokenization configuration is used for obtaining a sensing token from the sensed data; and

a transmitting module 2706, configured to transmit a sensing result to the central device when the sensed data and the semantic token are matched, where the sensing result indicates the sensed data.

In a possible implementation, the first receiving module is specifically configured to receive the semantic token and the tokenization configuration broadcasted or multicasted by the central device.

In a possible implementation, the semantic token includes a semantic token for one task or a semantic token for one modality.

In a possible implementation, the apparatus further includes a second receiving module which is configured to receive an indication for a task identifier or an indication for a modality identifier.

In a possible implementation, the semantic token includes multiple semantic tokens for multiple tasks and multiple task identifiers respectively associated with the multiple semantic tokens.

In a possible implementation, the semantic token includes multiple semantic tokens for multiple modalities and multiple modality identifiers respectively associated with the multiple semantic tokens.

In a possible implementation, the semantic token includes first multiple semantic tokens for multiple tasks, second multiple semantic tokens for multiple modalities, multiple task identifiers respectively associated with the first multiple semantic tokens, and multiple modality identifiers respectively associated with the second multiple semantic tokens.

In a possible implementation, the sensing result includes one of the following: raw sensed data; a sensing semantic obtained from raw sensed data; half raw sensed data and a sensing semantic obtained from raw sensed data; raw sensed data and a matching score between the sensed data and the semantic token; raw sensed data and a distance between the sensed data and the semantic token; a sensing semantic obtained from raw sensed data and a matching score between the sensed data and the semantic token; a sensing semantic obtained from raw sensed data and a distance between the sensed data and the semantic token; half raw sensed data, a sensing semantic obtained from raw sensed data, and a matching score between the sensed data and the semantic token; half raw sensed data, a sensing semantic obtained from raw sensed data, and a distance between the sensed data and the semantic token.

In a possible implementation, the sensing result further includes a task identifier or a modality identifier.

In a possible implementation, the sensing result further includes an identifier of a semantic token of which the matching score is greater than or equal to a first threshold or the distance is less than a second threshold.

In a possible implementation, the sensing result further includes identifiers of semantic tokens of which matching scores are greater than or equal to a first threshold or distances are less than a second threshold.

In a possible implementation, the first receiving module is specifically configured to: receive a sequence of a pre-defined length and the tokenization configuration from the central device.

In a possible implementation, the sequence of the pre-defined length includes an amble, a mask code, or an interleaving sequence.

In a possible implementation, the first receiving module is specifically configured to: receive a payload with a fixed modulation and coding scheme (MCS) and the tokenization configuration from the central device.

In a possible implementation, the apparatus further includes an obtaining module, a translating module, and a tokenizing module, where the obtaining module is configured to obtain the sensed data, the translating module is configured to translate the sensed data into a sensing semantic according to a semantization configuration, the tokenizing module is configured to tokenize the sensing semantic into the sensing token according to the tokenization configuration; and the determining module is specifically configured to determine whether the sensing token and the semantic token are matched.

In a possible implementation, the determining module is specifically configured to: determine whether a matching score between the sensing token and the semantic token is greater than or equal to a first threshold; or, determine whether a distance between the sensing token and the semantic token is less than or equal to a second threshold.

In a possible implementation, the tokenization configuration includes one of: a tokenization model; a tokenization function; a projection matrix; a graph-based or topology-based pruning; a compression approach.

In a possible implementation, the apparatus further includes a third receiving module, configured to receive at least one of a scoring function for determining a matching score between the sensed data and the semantic token, a first threshold, a function for determining a distance between the sensed data and the semantic token, or a second threshold from the central device.

In a possible implementation, the first receiving module is specifically configured to receive the semantic token, the tokenization configuration and at least one of a scoring function for determining a matching score between the sensed data and the semantic token, a first threshold, a function for determining a distance between the sensed data and the semantic token, or a second threshold from the central device.

In a possible implementation, the semantic token is carried in higher layer signaling or physical layer signaling or a combination of higher layer signaling and physical signaling, where the higher layer signaling includes one of radio resource control (RRC) signaling, medium access control (MAC) layer signaling, and the physical layer signaling includes downlink control information (DCI).

In a possible implementation, the semantic token includes a query token.

The communication apparatus may be applied to the sensing device as described in the above method examples or may be the sensing device as described in the above method examples. It should be understood by a person skilled in the art that, the relevant description of the modules in the examples of the present disclosure may be understood with reference to the relevant description of the communication method in the examples of the present disclosure.

As illustrated in FIG. 28, the present disclosure provides a communication apparatus 2800 including:

a first transmitting module 2802, configured to transmit a semantic token and a tokenization configuration to a sensing device; and

a first receiving module 2804, configured to receive a sensing result from the sensing device, where sensed data of the sensing device and the semantic token are matched, the tokenization configuration is used for obtaining a sensing token from the sensed data, and the sensing result indicates the sensed data.

In a possible implementation, the first transmitting module is specifically configured to broadcast or multicast the semantic token and the tokenization configuration to a plurality of sensing devices.

In a possible implementation, the semantic token includes a semantic token for one task or a semantic token for one modality.

In a possible implementation, the apparatus further includes a second transmitting module, configured to transmit an indication for a task identifier or an indication for a modality identifier.

In a possible implementation, the semantic token includes multiple semantic tokens for multiple tasks and multiple task identifiers respectively associated with the multiple semantic tokens.

In a possible implementation, the semantic token includes multiple semantic tokens for multiple modalities and multiple modality identifiers respectively associated with the multiple semantic tokens.

In a possible implementation, the semantic token includes first multiple semantic tokens for multiple tasks, second multiple semantic tokens for multiple modalities, multiple task identifiers respectively associated with the first multiple semantic tokens, and multiple modality identifiers respectively associated with the second multiple semantic tokens.

In a possible implementation, the sensing result includes one of the following: raw sensed data; a sensing semantic obtained from raw sensed data; half raw sensed data and a sensing semantic obtained from raw sensed data; raw sensed data and a matching score between the sensed data and the semantic token; raw sensed data and a distance between the sensed data and the semantic token; a sensing semantic obtained from raw sensed data and a matching score between the sensed data and the semantic token; a sensing semantic obtained from raw sensed data and a distance between the sensed data and the semantic token; half raw sensed data, a sensing semantic obtained from raw sensed data, and a matching score between the sensed data and the semantic token; half raw sensed data, a sensing semantic obtained from raw sensed data, and a distance between the sensed data and the semantic token.

In a possible implementation, the sensing result further includes a task identifier or a modality identifier.

In a possible implementation, the sensing result further includes an identifier of a semantic token of which the matching score is greater than or equal to a first threshold or the distance is less than a second threshold.

In a possible implementation, the sensing result further includes identifiers of semantic tokens of which matching scores are greater than or equal to a first threshold or distances are less than a second threshold.

In a possible implementation, the apparatus further includes a first encoding module, configured to encode the semantic token into a sequence of a pre-defined length; and the first transmitting module is specifically configured to transmit the sequence of the pre-defined length and the tokenization configuration to a sensing device.

In a possible implementation, the sequence of the pre-defined length includes an amble, a mask code, or an interleaving sequence.

In a possible implementation, the apparatus further includes a second encoding module, configured to encode the semantic token into a payload with a fixed modulation and coding scheme (MCS); and the first transmitting module is specifically configured to transmit the payload with the fixed MCS and the tokenization configuration to a sensing device.

In a possible implementation, the semantic token includes a query token.

In a possible implementation, the apparatus further includes a second receiving module, a tokenizing module and an outputting module, where the second receiving module is configured to receiving a semantic from a generative pre-trained transformer (GPT) device, the tokenizing module is configured to tokenize the semantic into the semantic token, and the outputting module is configured to output the sensing result to the GPT device.

In a possible implementation, the apparatus further includes a first determining module, configured to determine the tokenization configuration.

In a possible implementation, the apparatus further includes a second determining module, configured to determine a token length of the semantic token.

In a possible implementation, the tokenization configuration includes one of: a tokenization model; a tokenization function; a projection matrix; a graph-based or topology-based pruning; a compression approach.

In a possible implementation, the method further includes a third transmitting module, configured to: transmit at least one of a scoring function for determining a matching score between the sensed data and the semantic token, a first threshold, a function for determining a distance between the sensed data and the semantic token, or a second threshold, to the sensing device.

In a possible implementation, the first transmitting module is specifically configured to: transmit the semantic token, the tokenization configuration and at least one of a scoring function for determining a matching score between the sensed data and the semantic token, a first threshold, a function for determining a distance between the sensed data and the semantic token, or a second threshold, to the sensing device.

In a possible implementation, the semantic token is carried in higher layer signaling or physical layer signaling or a combination of higher layer signaling and physical signaling, where the higher layer signaling includes one of radio resource control (RRC) signaling, medium access control (MAC) layer signaling, and the physical layer signaling includes downlink control information (DCI).

The communication apparatus may be applied to the central device as described in the above method examples or may be the central device as described in the above method examples. It should be understood by a person skilled in the art that, the relevant description of the modules in the examples of the present disclosure may be understood with reference to the relevant description of the communication method in the examples of the present disclosure.

The present disclosure provides a sensing device including processing circuitry for executing any of the above communication method. It should be understood that the sensing device can execute the steps performed by the sensing device in the method examples, which will not be repeated here.

The present disclosure provides a central device including processing circuitry for executing any of the above communication method. It should be understood that the central device can execute the steps performed by the central device in the method examples, which will not be repeated here.

The present disclosure provides a communication system, including a central device and a sensing device. The sensing device is configured to execute the steps executed by the sensing device in any of the communication method, and the central device is configured to execute the steps executed by the central device in any of the communication method.

The present disclosure provides a communication system, including a sensing device and at least one of a central device and a GPT device. The sensing device is configured to execute the steps executed by the sensing device in any of the communication method, and the central device/the GPT device is configured to execute the steps executed by the central device in any of the communication method.

The present disclosure provides a chip, including an input/output (I/O) interface and a processor, where the processor is configured to call and run computer execution instructions stored in a memory, to enable a device installing with the chip to execute any of the above communication methods.

The present disclosure provides a computer-readable medium storing computer execution instructions which, when executed by a processor, causes the processor to execute any of the above communication methods.

The present disclosure provides a computer program product including computer execution instructions which, when executed by a processor, causes the processor to execute any of the above communication methods.

The present disclosure provides a computer program including computer execution instructions which, when executed by a processor, causes the processor to execute any of the above communication methods.

In the present disclosure, a method for token based semantic/task query and response is provided. Some aspects of the present disclosure relate to a scheme of a semantic-based communication to manage and schedule a large number of sensing devices, in which the sensing devices may belong to different types. The query semantics are goal-oriented and only the sensing device whose sensed data has sufficient relevance with the semantic message(s) would response and transmit their sensed data that are preferably in semantic form too.

Some aspects of the present disclosure relate to a scheme of a collective semantic token-based scheduling over a large number of sensing devices rather than one-to-one individual scheduling.

Some aspects of the present disclosure relate to a scheme of using the large-Language-model (LLM) to turn query and sensed data into a common semantic domain on which they can be easily compared to each other and fused.

The above one or more aspects of the present disclosure may have at least one of the following benefits:

Scheduling may be task-oriented or goal-oriented; only the sensing devices that has contributions to a scheduled task or goal will response and transmit their sensed data;

Privacy may be protected: both the task, goal, or query and sensed data are well protected; no raw data or minimum raw data or message is transmitted over the air;

Forward compatible: semantic-based sensing system in this disclosure may be forward compatible in a sense that any new sensing mechanism can be supported.

In some aspects of the present disclosure, there is provided a computer program comprising instructions. The instructions, when executed by a processor, may cause the processor to implement the method of the present disclosure.

In some aspects of the present disclosure, there is provided a non-transitory computer-readable medium storing instructions, the instructions, when executed by a processor, may cause the processor to implement the method of the present disclosure.

In some aspects of the present disclosure, there is provided an apparatus/chipset system comprising means to implement the method implemented by the sensing device of the present disclosure.

In some aspects of the present disclosure, there is provided an apparatus/chipset system comprising means to implement the method implemented by the central device of the present disclosure.

In some aspects of the present disclosure, there is provided an apparatus/chipset system comprising means to implement the method implemented by the GPT device of the present disclosure.

In some aspects of the present disclosure, there is provided a system comprising at least two of an apparatus in the sensing device of the present disclosure, an apparatus in the central device of the present disclosure and an apparatus in the GPT device of the present disclosure.

In some aspects of the present disclosure, there is provided an apparatus/chipset system comprising at least one processor executing instructions stored in a computer-readable medium to implement the method implemented by the sensing device of the present disclosure.

In some aspects of the present disclosure, there is provided an apparatus/chipset system comprising at least one processor executing instructions stored in a computer-readable medium to implement the method implemented by the central device of the present disclosure.

In some aspects of the present disclosure, there is provided an apparatus/chipset system comprising at least one processor executing instructions stored in a computer-readable medium to implement the method implemented by the GPT device of the present disclosure.

Please note that the different examples may be implemented separately or combined. Although a combination of features is shown in the illustrated embodiments, not all of them need to be combined to realize the benefits of various examples of the present disclosure. In other words, a system or method designed in the present disclosure will not necessarily include all of the features shown in any one of the figures or all of the portions schematically shown in the figures. Moreover, selected features of one example embodiment may be combined with selected features of other example embodiments.

Although this disclosure has been described with reference to illustrative embodiments, the description is not intended to be construed in a limiting sense. Various modifications and combinations of the illustrative embodiments, as well as other examples of the disclosure, will be apparent to persons skilled in the art upon reference to the description. It is therefore intended that the appended claims encompass any such modifications or examples.

Although the present disclosure describes methods and processes with steps in a certain order, one or more steps of the methods and processes may be omitted or altered as appropriate. One or more steps may take place in an order other than that in which they are described, as appropriate.

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein. The machine-executable instructions may be in the form of code sequences, configuration information, or other data, which, when executed, cause a machine (e.g., a processor or other processing device) to perform steps in a method according to examples of the present disclosure.

The present disclosure may be embodied in other specific forms without departing from the subject matter of the claims. The described examples are to be considered in all respects as being only illustrative and not restrictive. Selected features from one or more of the above-described examples may be combined to create alternative examples not explicitly described, features suitable for such combinations being understood within the scope of this disclosure.

All values and sub-ranges within disclosed ranges are also disclosed. Also, although the systems, devices and processes disclosed and shown herein may include a specific number of elements/components, the systems, devices and assemblies could be modified to include additional or fewer of such elements/components. For example, although any of the elements/components disclosed may be referenced as being singular, the examples disclosed herein could be modified to include a plurality of such elements/components. The subject matter described herein intends to cover and embrace all suitable changes in technology.

Although examples have been described above with reference to the accompanying drawings, those of skill in the art will appreciate that variations and modifications may be made without departing from the scope thereof as defined by the appended claims.

What is claimed is:

1. A method, comprising:
receiving a semantic token and a tokenization configuration from a central device;
determining whether a sensing token and the semantic token are matched, wherein the tokenization configuration is used for obtaining the sensing token from sensed data; and
transmitting a sensing result to the central device when the sensing token and the semantic token are matched, wherein the sensing result indicates the sensed data.

2. The method according to claim 1, wherein the sensing result comprises one of the following:
raw sensed data;
a sensing semantic obtained from raw sensed data;
half raw sensed data and a sensing semantic obtained from raw sensed data;
raw sensed data and a matching score between the sensed data and the semantic token;
raw sensed data and a distance between the sensed data and the semantic token;
a sensing semantic obtained from raw sensed data and a matching score between the sensed data and the semantic token;
a sensing semantic obtained from raw sensed data and a distance between the sensed data and the semantic token;
half raw sensed data, a sensing semantic obtained from raw sensed data, and a matching score between the sensed data and the semantic token; or
half raw sensed data, a sensing semantic obtained from raw sensed data, and a distance between the sensed data and the semantic token.

3. The method according to claim 1, further comprising:
obtaining the sensed data;
translating the sensed data into a sensing semantic according to a semantization configuration; and
tokenizing the sensing semantic into the sensing token according to the tokenization configuration.

4. The method according to claim 3, wherein determining whether the sensing token and the semantic token are matched comprises:
determining whether a matching score between the sensing token and the semantic token is greater than or equal to a first threshold; or
determining whether a distance between the sensing token and the semantic token is less than or equal to a second threshold.

5. The method according to claim 1, wherein the tokenization configuration comprises one of:
a tokenization model;
a tokenization function;
a projection matrix;
a graph-based or topology-based pruning; or
a compression approach.

6. The method according to claim 1, further comprising:
receiving at least one of a scoring function for determining a matching score between the sensed data and the semantic token, a first threshold, a function for determining a distance between the sensed data and the semantic token, or a second threshold from the central device.

7. The method according to claim 1, wherein the semantic token is carried in higher layer signaling or physical layer signaling or a combination of higher layer signaling and physical signaling;
wherein the higher layer signaling comprises one of radio resource control (RRC) signaling or medium access control (MAC) layer signaling; and
wherein the physical layer signaling comprises downlink control information (DCI).

8. An apparatus, comprising:
at least one processor coupled with a memory storing instructions, wherein when the instructions are executed by the at least one processor, the apparatus is caused to:
receive a semantic token and a tokenization configuration from a central device;
determine whether a sensing token and the semantic token are matched, wherein the tokenization configuration is used for obtaining the sensing token from sensed data; and
transmit a sensing result to the central device when the sensing token and the semantic token are matched, wherein the sensing result indicates the sensed data.

9. The apparatus according to claim 8, wherein the sensing result comprises one of the following:
raw sensed data;
a sensing semantic obtained from raw sensed data;
half raw sensed data and a sensing semantic obtained from raw sensed data;
raw sensed data and a matching score between the sensed data and the semantic token;
raw sensed data and a distance between the sensed data and the semantic token;
a sensing semantic obtained from raw sensed data and a matching score between the sensed data and the semantic token;
a sensing semantic obtained from raw sensed data and a distance between the sensed data and the semantic token;
half raw sensed data, a sensing semantic obtained from raw sensed data, and a matching score between the sensed data and the semantic token; or
half raw sensed data, a sensing semantic obtained from raw sensed data, and a distance between the sensed data and the semantic token.

10. The apparatus according to claim 8, wherein when the instructions are executed by the at least one processor, the apparatus is further caused to:
obtain the sensed data;
translate the sensed data into a sensing semantic according to a semantization configuration; and
tokenize the sensing semantic into the sensing token according to the tokenization configuration.

11. The apparatus according to claim 10, wherein determining whether the sensing token and the semantic token are matched comprises:
determining whether a matching score between the sensing token and the semantic token is greater than or equal to a first threshold; or
determining whether a distance between the sensing token and the semantic token is less than or equal to a second threshold.

12. The apparatus according to claim 8, wherein the tokenization configuration comprises one of:
a tokenization model;
a tokenization function;
a projection matrix;
a graph-based or topology-based pruning; or
a compression approach.

13. The apparatus according to claim 8, wherein when the instructions are executed by the at least one processor, the apparatus is further caused to:
receive at least one of a scoring function for determining a matching score between the sensed data and the semantic token, a first threshold, a function for determining a distance between the sensed data and the semantic token, or a second threshold from the central device.

14. The apparatus according to claim 8, wherein the semantic token is carried in higher layer signaling or physical layer signaling or a combination of higher layer signaling and physical signaling;
wherein the higher layer signaling comprises one of radio resource control (RRC) signaling, medium access control (MAC) layer signaling; and
wherein the physical layer signaling comprises downlink control information (DCI).

15. A apparatus, comprising:
at least one processor coupled with a memory storing instructions, wherein when the instructions are executed by the at least one processor, the apparatus is caused to:
transmit a semantic token and a tokenization configuration to a sensing device; and
receive a sensing result from the sensing device, wherein a sensing token of the sensing device and the semantic token are matched, the tokenization configuration is used for obtaining the sensing token from sensed data, and the sensing result indicates the sensed data.

16. The apparatus according to claim 15, wherein the sensing result comprises one of the following:
raw sensed data;
a sensing semantic obtained from raw sensed data;
half raw sensed data and a sensing semantic obtained from raw sensed data;
raw sensed data and a matching score between the sensed data and the semantic token;
raw sensed data and a distance between the sensed data and the semantic token;
a sensing semantic obtained from raw sensed data and a matching score between the sensed data and the semantic token;
a sensing semantic obtained from raw sensed data and a distance between the sensed data and the semantic token;
half raw sensed data, a sensing semantic obtained from raw sensed data, and a matching score between the sensed data and the semantic token; or
half raw sensed data, a sensing semantic obtained from raw sensed data, and a distance between the sensed data and the semantic token.

17. The apparatus according to claim 15, wherein when the instructions are executed by the at least one processor, the apparatus is further caused to:
receive a semantic from a device running over at least one artificial intelligence (AI) model;
tokenize the semantic into the semantic token;
output the sensing result to the device.

18. The apparatus according to claim 15, wherein the tokenization configuration comprises one of:
a tokenization model;
a tokenization function;
a projection matrix;
a graph-based or topology-based pruning; or
a compression approach.

19. The apparatus according to claim 15, wherein when the instructions are executed by the at least one processor, the apparatus is further caused to:
transmit at least one of a scoring function for determining a matching score between the sensed data and the semantic token, a first threshold, a function for determining a distance between the sensed data and the semantic token, or a second threshold, to the sensing device.

20. The apparatus according to claim 15, wherein the semantic token is carried in higher layer signaling or physical layer signaling or a combination of higher layer signaling and physical signaling;
wherein the higher layer signaling comprises one of radio resource control (RRC) signaling, medium access control (MAC) layer signaling; and
the physical layer signaling comprises downlink control information (DCI).
